(19) United States
(12) Patent Application Publication
(10) Pub. No.: US 2022/0380515 A1
(43) Pub. Date: Dec. 1, 2022

(54) A CURABLE COMPOSITION AND A METHOD FOR APPLYING THE SAME

(71) Applicant: Dow Global Technologies LLC, Midland, MI (US)

(72) Inventors: Yongchun Chen, Shanghai (CN); Zhengming Tang, Shanghai (CN); Hongyu Chen, Zhangjiang (CN); Jian Kang, Shanghai (CN); Xiuqing Xu, Shanghai (CN); Nan Wang, Shanghai (CN); Qingwei Meng, Shanghai (CN); Chuanwei Zuo, Guangzhou (CN)

(21) Appl. No.: 17/774,171

(22) PCT Filed: Nov. 15, 2019
(86) PCT No.: PCT/CN2019/118725

§ 371 Date: May 4, 2022

(51) Int. Cl. C08G 18/28; C08G 18/18; C08G 18/48

(52) U.S. Cl. CPC C08G 18/289; C08G 18/1825; C08G 18/4825; C08G 2150/00

(57) ABSTRACT

Described is a curable composition comprising a silane modified polymer; an epoxy resin terminated with epoxy terminal group; a compatibilizer having at least one silane group and at least one epoxy terminal group or at least one nitrogen-containing groups; and optionally a hardening agent; wherein the composition further optionally comprises at least one of a nitrogen-containing unsaturated heterocyclic compound catalyst and a nitrogen-containing phenol catalyst. The curable composition exhibits high hermeticity, fast curing speed, quick adhesion build up, dry surface and strong adhesion strength. A method for applying the curable composition on the surface of a substrate is also provided.

### FIELD OF THE INVENTION

The present disclosure relates to a curable composition, particularly a fast-drying composition and a method for applying the same on the surface of a substrate. The curable composition exhibits superior performance properties such as high hermeticity, fast curing speed, quick adhesion build up, dry surface and strong adhesion strength.

### BACKGROUND TECHNOLOGY

Silane-modified polymers (SMP), also known as silylated polymers, are versatile, high value industrial resins widely accepted for a large variety of applications. Silane modified polymer (SMP) based adhesives/sealants are gaining more and more popularity due to many advantages such as low VOC, iso-free and bubble-free, good balance of performance properties and durability, etc. Particularly speaking, the SMP based adhesives are superior over silicone based adhesives in that the former exhibits higher adhesion strength and can be overpainted with additional paint or coating material. Furthermore, the SMP based adhesives are superior over adhesives formulated with polyurethane prepolymers in the durability.

The SMP-based adhesives/sealants have been used in various applications including prefabricate construction (PC), home decoration, transportation [vehicle, vessel, automotive, aircraft and high speed railway (HSR)], industrial assembly and home appliance etc. Nevertheless, these applications usually require fast drying/curing speed while still retaining good mechanical strengths such as high adhesion strength, shear strength, elongation at break, elasticity, etc., especially for transportation, industrial assembly and home appliance. For example, quite a few customers have been asking for SMP based adhesives with a skin formation time of 5 minutes to 20 minutes, the establishment of acceptable adhesion strength within 20 minutes, a shear strength of larger than 2 MPa after one week, good surface properties (e.g. dry surface) and reliable hermeticity during the whole service life.

Such high requirements on the curing speed and mechanical strengths are generally considered as a huge challenge to the SMP based adhesives as most SMP based adhesives commercially sold in the market can only achieve a drying time of over 30 minutes and will exhibit inferior mechanical strength and hermeticity even after 24 hours or after 1 week. Numerous efforts have been made by many researchers to modify factors such as fillers, resin ratio, adhesion promoters and catalysts, etc., but none of these researches of the prior art can successfully meet the above indicated requirements.

None of the existing SMP based adhesive can achieving an acceptable curing speed while retaining superior mechanical strength in the final adhesion coating. Without being limited to any specific theory, it is suspected that the inferior mechanical strength of the existing SMP based adhesive is at least partially due to the absence of any chemical linkage between the SMP phase and the other phase(s) used in combination with the same. An adhesive composition of the prior art is shown in FIG. 1, wherein the incorporation of various additives (such as hardening agent, catalyst, reaction accelerator, surfactant, etc.) and compatibilizer will not establish any chemical linkage between the SMP phase and an epoxy phase, hence the resultant blend comprises chemically isolated SMP phase and an epoxy phase, thus exhibiting inferior mechanical strength. Besides, the slow curing speed of prior art SMP based adhesives are due to lack of suitable catalyst packaging and water in the recipe. Furthermore, plasticizer is widely applied in the existing SMP based sealant, and oil surface or sticky surface is a big issue to be addressed.

After persistent exploration, the inventors have surprisingly developed an epoxy-SMP hybrid curable composition which can achieve one or more of the above targets. In particular, it was found that the inclusion of specific catalyst packaging and water in epoxy-SMP hybrid formulations successfully achieves a high curing speed, the addition of specific compatibilizer can further enhance the mechanical strength to a desirable level, and desirable surface feeling can be achieved by particularly design the relative amounts of the above stated additives.

### SUMMARY OF THE INVENTION

The present disclosure provides a unique curable composition, particularly a fast-drying composition and a method for applying the curable composition on a surface of a substrate.

In a first aspect of the present disclosure, the present disclosure provides a curable composition, and particularly a fast-drying curable composition, comprising

at least one silane modified polymer;

at least one epoxy resin terminated with epoxy group;

at least one compatibilizer which has at least one silane group and at least one epoxy terminal group, or has at least one silane group and at least one nitrogen-containing group, such as amine group or imine group, in the same molecule;

optionally, at least one hardening agent;

optionally, at least one nitrogen-containing unsaturated heterocyclic compound catalyst; and

optionally, at least one nitrogen-containing phenol catalyst.

In a second aspect of the present disclosure, the present disclosure provides a method for applying said curable composition onto a surface of a substrate, comprising the steps of combining the silane modified polymer, the epoxy resin, the compatibilizer, and the optional the optional hardening agent, nitrogen-containing unsaturated heterocyclic compound catalyst and nitrogen-containing phenol catalyst to form a precursor blend; (2) applying the precursor blend onto a surface of a substrate; and (3) curing the precursor blend, or allowing the precursor blend to cure.

It is to be understood that both the foregoing general description and the following detailed description are exemplary and explanatory only and are not restrictive of the invention, as claimed.

### BRIEF DESCRIPTION OF THE DRAWINGS

FIG. 1 is a schematic illustration of a curable composition of the prior art;

FIG. 2 is a schematic illustration of an embodiment of the curable composition described herein;

FIG. 3 shows the reaction mechanism of a silylation reaction for preparing a polyol-based SMP according to an embodiment of the present disclosure;

FIG. 4 shows the reaction mechanism of a hydrosilylation reaction for preparing a polyol-based SMP according to another embodiment of the present disclosure;

FIG. 5 shows the reaction mechanism of a silylation reaction for preparing a polyurethane-based SMP according to an embodiment of the present disclosure;

FIG. 6 shows the influence of SMP/epoxy weight ratio on the lap shear strength according to several embodiments of the present disclosure;

FIG. 7 shows the lap shear strength of a curable composition according to an embodiment of the present disclosure on different substrates;

FIG. 8 shows the influence of formulations of the curable composition on the lap shear strength according to several embodiments of the present disclosure; and

FIG. 9 shows the influence of formulations of the curable composition on the lap shear strength according to several embodiments of the present disclosure.

### DETAILED DESCRIPTION OF THE INVENTION

Unless defined otherwise, all technical and scientific terms used herein have the same meaning as commonly understood by one of ordinary skill in the art to which the invention belongs. Also, all publications, patent applications, patents, and other references mentioned herein are incorporated by reference.

As disclosed herein, “and/or” means “and, or as an alternative”. All ranges include endpoints unless otherwise indicated. Unless indicated otherwise, all the percentages and ratios are calculated based on weight, and all the molecular weights are number average molecular weights.

According to a preferable embodiment of the present disclosure, the curable composition of the present disclosure is a “two-component”, “two-part” or “two-package” composition comprising component (A) which has a silane modified polymer, an epoxy resin, a compatibilizer having at least one silane group and at least one epoxy terminal group; and component (B) which has a hardening agent, the nitrogen-containing unsaturated heterocyclic compound catalyst and the nitrogen-containing phenol catalyst.

According to another preferable embodiment of the present disclosure, the curable composition of the present disclosure is a “two-component”, “two-part” or “two-package” composition comprising component (A) which has a silane modified polymer, a compatibilizer having at least one silane group and at least one nitrogen-containing group, e.g. amine group or imine group, in the same molecule, optionally, the nitrogen-containing unsaturated heterocyclic compound catalyst; and component (B) which comprises the epoxy resin.

According to another preferable embodiment of the present disclosure, the curable composition of the present disclosure is a “three-component”, “three-part” or “three-package” composition comprising component (A1) which has a silane modified polymer; component (A2) which comprises an epoxy resin; and component (B) which has a hardening agent, the nitrogen-containing unsaturated heterocyclic compound catalyst and the nitrogen-containing phenol catalyst. The compatibilizer may be contained in either of the component (A1) or the component (A2) but it could not be contained in component (B).

The above stated components (A), (A1), (A2) and (B) may further comprise optional additives such as catalyst, filler, pigment, plasticizer, thixitrope agent, antioxidant, light stabilizer, moisture scavenger, etc. Furthermore, one or more of the above stated ingredients and additives may be provided as one or more additional independent components, thus the above stated two-component or three-component composition may be divided into a “three-component”, “four-component” or even a “five-component”. All of these variations are within the protection scope of the present disclosures.

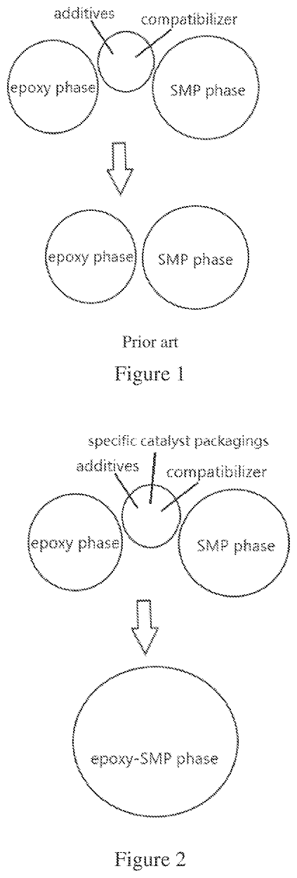

For the sake of convenience, the most preferable embodiment of the present disclosure is a “two-component” composition. Once combined, the reactive groups in each components, such as the epoxy terminal groups in the epoxy resin or compatibilizer, the silane/siloxane groups in the SMP or compatibilizer, the amine and imine groups in the compatibilizer or the hardening agent, the epoxy terminal groups/silane/siloxane groups contained in the compatibilizer, and any other reactive groups contained in the other additives or reactants, react with each other to establish a chemically integrated combination of SMP-epoxy resin. According to various embodiments of the present disclosure, once combined, the SMP phase is chemically linked with the epoxy resin via the compatibilizer and the optional hardening agent, when present. Without being limited to any specific theory, an exemplary embodiment of the present disclosure is shown in FIG. 2. It shall be noted that although it is indicated in FIG. 2 that the SMP phase and the epoxy resin phase has been integrated into an epoxy-SMP phase, it does not mean that the molecules SMP and epoxy resin are linked by direct covalent bond, and it is hypothesized that the integration of the two phases can be achieved by the action (e.g. synergic action) of the compatibilizer and the optional hardening agent, when present. The comparison between FIG. 1 and FIG. 2 clearly shows the difference between the chemically integrated combination of the present disclosure and the chemically isolated system of the prior art. Without being limited to any specific theory, it is suspected that the incorporation of the particularly designed compatibilizer and optional hardener in the composition of the present disclosure can effectively achieve a chemically integrated combination of SMP-epoxy resin, thus successfully enhance the mechanical strength and hermeticity of the resultant composition. Without being limited to any specific theory, the incorporation of two catalysts (i.e. the nitrogen-containing unsaturated heterocyclic compound catalyst and the nitrogen-containing phenol catalyst) significantly enhances the curing speed of the resultant composition.

According to various embodiments of the present disclosure, the curable composition of the present disclosure is a two-component composition which can be an adhesive, sealant, coating or concrete, and is preferably a 2K adhesive or a 2K sealant. The curable composition of the present disclosure can be applied on the surface of a substrate to form a coating film, a concrete layer or a sealant layer thereof to achieve the functions of physical/chemical protection, sonic/thermal/irradiation barrier, filling material, supporting/carrying/construction structure, decorative layer or sealing/hermetic/waterproof layer. Besides, when the curable composition of the present disclosure is used as an adhesive, it can be used for adhering two or more identical or different substrates together. According to an embodiment of the present disclosure, the substrate is at least one member selected from the group consisting of metal, masonry, concrete, paper, cotton, fiberboard, paperboard, wood, woven or nonwoven fabrics, elastomers, polycarbonates, phenol resins, epoxy resins, polyesters, polyethylencarbonate, synthetic and natural rubber, silicon, and silicone polymers. According to another embodiment of the present disclosure, the substrate is a polymer substrate selected from the group consisting of polymethylmethacrylate, polypropylenecarbonate, polybutenecarbonate, polystyrene, acrylonitrile-butadiene-styrene resin, acrylic resin, polyvinyl chloride, polyvinyl alcohol, polycarbonates, polyethylene terephthalate, polyurethanes, polyimides, and copolymers thereof. According to another embodiment of the present disclosure, the substrate is selected from the group consisting of wood, polystyrene, nylon, and acrylonitrile-butadiene-styrene. According to another embodiment of the present disclosure, the substrate is a metal substrate selected from the group consisting of aluminum, aluminum alloy, stainless steel, galvanized steel, cast iron, brass, bronze, titanium, titanium alloy, magnesium alloy, zinc alloy, and any combinations thereof.

The Silane Modified Polymer (SMP)

According to various embodiments of the present disclosure, the silane modified polymer (SMP) can be a polymer having silane groups. For examples, the SMP can be represented by formula I:

R¹ₘ(R²O)₍₃₋ₘ₎Si—R⁷-(polymeric main chain)-R⁸—SiR³ₙ(R⁴O)₍₃₋ₙ₎ Formula I

wherein the polymeric main chain is derived from a polyol, or derived from at least one polyisocyanate and at least one polyol, and is optionally functionalized with at least one —R⁹—SiR⁵ₛ(R⁶O)₍₃₋ₛ₎, each of R¹, R², R³, R⁴, R⁵ and R⁶ independently represents a hydrogen atom or a C₁-C₆ alkyl group, each of m, n and s represents an integrate of 0, 1 or 2, each of R⁷, R⁸ and R⁹ independently represents a direct bond, —O—, a divalent (C₁ to C₆ alkylene) group, —O—(C₁ to C₆ alkylene) group, (C₁ to C₆ alkylene)-O— group, —O—(C₁ to C₆ alkylene)-O— group, —N(R_{N})—(C₁ to C₆ alkylene) group or —C(═O)—N(R_{N})—(C₁ to C₆ alkylene) group, wherein R_{N} represents a hydrogen atom or a C₁-C₆ alkyl group.

According to an embodiment of the present disclosure, the polymeric main chain can be derived from a polyether polyol or a polyester polyol.

In the context of the present disclosure, the “silane modification” or “silylation reaction” refers to the attachment of the groups “R¹ₘ(R²O)₍₃₋ₘ₎Si—R⁷—”, “—R⁸—SiR³ₙ(R⁴O)₍₃₋ₙ₎” and “—R⁹—SiR⁵ₛ(R⁶O)₍₃₋ₛ₎” to the polymeric main chain in the SMP, and all the above stated silicone-containing substitution groups (no matter the groups R¹—, R²O—, R³—, R⁴O—, R⁵— and R⁶O-actually refer to hydrogen, hydroxyl, alkyl or alkoxy groups) are collectively referred as “silane group”. The above stated “R¹ₘ(R²O)₍₃₋ₘ₎Si—R⁷—” and “—R⁸—SiR³ₙ(R⁴O)₍₃₋ₙ₎” represent terminal groups attached to the ends of the SMP, while the —R⁹—SiR⁵ₛ(R⁶O)₍₃₋ₛ₎ represents at least one side group attached to the intermediate repeating unit of the polymeric main chain.

In the context of the present disclosure, the C₁-C₆ alkyl group includes methyl, ethyl, n-propyl, i-propyl, n-butyl, i-butyl, sec-butyl, t-butyl, n-pentyl, i-pentyl, tert-pentyl, neo-pentyl and n-hexyl; the C₁ to C₆ alkylene includes methylene, ethylene, propylene, butylene, pentamethylene and hexamethylene.

According to an embodiment of the present disclosure, the polymeric main chain is derived from a polyol, and the SMP represented by formula I may be prepared by reacting at least one reactive capping group (e.g. hydroxyl group or allyl group etc.) attached to the polyol (i.e. the polymeric main chain) with a trialkoxysilane group through silylation reaction or hydrosilylation reaction, or by reacting a polyisocyanate with a polyol to form a polyurethane intermediate, i.e. the polymeric main chain, which is then functionalized with a silanizing agent.

According to a preferable embodiment of the present disclosure, the polyurethane intermediate is a polyurethane chain having isocyanate terminal group, and the silanizing agent comprises a silane group on one end and an isocyanate-reactive group (such as hydroxyl group, amino group or amine group) on the other end. In the context of the present disclosure, the amine group can be a primary or a secondary amine group.

According to another preferable embodiment of the present disclosure, the polyurethane intermediate is a polyurethane chain having a hydroxyl terminal group, and the silanizing agent comprises a silane group on one end and an isocyanate group on the other end.

In various embodiments, the polyisocyanate compound for preparing the polymeric main chain (polyurethane chain) is an aliphatic, cycloaliphatic, aromatic or heteroaryl compound having at least two isocyanate groups. In a preferable embodiment, the polyisocyanate compound can be selected from the group consisting of C₄-C₁₂ aliphatic polyisocyanates comprising at least two isocyanate groups, C₆-C₁₅ cycloaliphatic or aromatic polyisocyanates comprising at least two isocyanate groups, C₇-C₁₅ araliphatic polyisocyanates comprising at least two isocyanate groups, and combinations thereof. In another preferable embodiment, suitable polyisocyanate compounds include m-phenylene diisocyanate, 2,4-toluene diisocyanate and/or 2,6-toluene diisocyanate (TDI), the various isomers of diphenylmethanediisocyanate (MDI), carbodiimide modified MDI products, hexamethylene-1,6-diisocyanate, tetramethylene-1,4-diisocyanate, cyclohexane-1,4-diisocyanate, hexahydrotoluene diisocyanate, hydrogenated MDI, naphthylene-1,5-diisocyanate, isophorone diisocyanate (IPDI), or mixtures thereof. Generally, the amount of the polyisocyanate compound may vary based on the actual requirement of the SMP and the resultant curable composition. For example, as one illustrative embodiment, the content of the polyisocyanate compound can be from 15 wt % to 60 wt %, or from 20 wt % to 50 wt %, or from 23 wt % to 40 wt %, or from 25 wt % to 38 wt %, based on the total weight of the SMP.

According to one embodiment of the present disclosure, the polyol for the polymeric main chain or for preparing the polyurethane main chain can be selected from the group consisting of C₂-C₁₆ aliphatic polyhydric alcohols comprising at least two hydroxyl groups, C₆-C₁₅ cycloaliphatic or aromatic polyhydric alcohols comprising at least two hydroxyl groups, C₇-C₁₅ araliphatic polyhydric alcohols comprising at least two hydroxyl groups, polyester polyols having a molecular weight from 100 to 5,000 and an average hydroxyl functionality of 1.5 to 5.0, a polyether polyol which is a poly(C₂-C₁₀)alkylene glycol or a copolymer of multiple (C₂-C₁₀)alkylene glycols having a molecular weight from 100 to 5,000, polycarbonate diols having a molecular weight from 100 to 5,000, and combinations thereof; and additional comonomers selected from the group consisting of C₂ to C₁₀ polyamine comprising at least two amino groups, C₂ to C₁₀ polythiol comprising at least two thiol groups and C₂-C₁₀ alkanolamine comprising at least one hydroxyl group and at least one amino groups, can also be used. According to a preferable embodiment, the polyol is a polyether polyol. In various embodiments, the polyether polyol used as the polyol has a molecular weight of 100 to 5,000 g/mol, and may have a molecular weight in the numerical range obtained by combining any two of the following end point values: 120, 150, 180, 200, 250, 300, 350, 400, 450, 500, 550, 600, 700, 800, 900, 1000, 1100, 1200, 1300, 1400, 1500, 1600, 1700, 1800, 1900, 2000, 2100, 2200, 2300, 2400, 2500, 2600, 2700, 2800, 2900, 3000, 3100, 3200, 3300, 3400, 3500, 3600, 3700, 3800, 3900, 4000, 4100, 4200, 4300, 4400, 4500, 4600, 4700, 4800, 4900 and 5000 g/mol. In various embodiments, the polyether polyol has an average hydroxyl functionality of 1.5 to 5.0, and may have an average hydroxyl functionality in the numerical range obtained by combining any two of the following end point values: 1.6, 1.7, 1.8, 1.9, 2.0, 2.1, 2.2, 2.3, 2.4, 2.5, 2.6, 2.7, 2.8, 2.9, 3.0, 3.1, 3.2, 3.3, 3.4, 3.5, 3.6, 3.7, 3.8, 3.9, 4.0, 4.1, 4.2, 4.3, 4.4, 4.5, 4.6, 4.7, 4.8, 4.9 and 5.0. According to one preferable embodiment, the polyol has an average kinematic viscosity of 500 to 1,200 cSt, or from 600 to 1,100 cSt, or from 700 to 1,000 cSt, or from 800 to 950 cSt, or from 850 to 920 cSt; and has an OH number of 10 to 100 mg KOH/g, or from 12 to 90 mg KOH/g, or from 15 to 80 mg KOH/g, or from 16 to 70 mg KOH/g, or from 17 to 60 mg KOH/g, or from 18 to 50 mg KOH/g, or from 19 to 40 mg KOH/g, or from 20 to 30 mg KOH/g, or from 25 to 28 mg KOH/g. According to a preferable embodiment of the present disclosure, the polyether polyol is selected from the group consisting of polyethylene glycol, polypropylene glycol, polytetramethylene glycol, poly(2-methyl-1,3-propane glycol) and any copolymers thereof, such as poly(ethylene oxide-propylene oxide) glycol. According to another preferable embodiment of the present disclosure, the polyether polyol may comprise at least one poly(C₂-C₁₀)alkylene glycol or copolymer thereof, for example, the polyether polyol may be selected from the group consisting of (methoxy)polyethylene glycol (MPEG), polyethylene glycol (PEG), poly(propylene glycol), polytetramethylene glycol, poly(2-methyl-1,3-propane glycol) or copolymer of ethylene epoxide and propylene epoxide (polyethylene glycol-propylene glycol) with primary hydroxyl ended group or secondary hydroxyl ended group.

According to an embodiment of the present disclosure, the polyether polyols can be prepared by polymerization of one or more linear or cyclic alkylene oxides selected from propylene oxide (PO), ethylene oxide (EO), butylene oxide, tetrahyfrofuran, 2-methyl-1,3-propane glycol and mixtures thereof, with proper starter molecules in the presence of a catalyst. Typical starter molecules include compounds having at least 1, preferably from 1.5 to 3.0 hydroxyl groups or having one or more primary amine groups in the molecule. Suitable starter molecules having at least 1 and preferably from 1.5 to 3.0 hydroxyl groups in the molecules are for example selected from the group comprising ethylene glycol, 1,2-propanediol, 1,3-propanediol, 1,2-butanediol, 1,3-butanediol, 1,4-butenediol, 1,4-butynediol, 1,5-pentanediol, neopentyl glycol, 1,4-bis(hydroxymethyl)-cyclohexane, 1,2-bis(hydroxymethyl)cyclohexane, 1,3-bis(hydroxymethyl)-cyclohexane, 2-methylpropane-1,3-diol, methylpentanediols, diethylene glycol, triethylene glycol, tetraethylene glycol, polyethylene glycol, dipropylene glycol, polypropylene glycol, dibutylene glycol, polybutylene glycols, trimethylolpropane, glycerol, pentaerythritol, castor oil, sugar compounds such as, for example, glucose, sorbitol, mannitol and sucrose, polyhydric phenols, resols, such as oligomeric condensation products of phenol and formaldehyde and Mannich condensates of phenols, formaldehyde and dialkanolamines, and also melamine. Starter molecules having one or more primary amine groups in the molecules may be selected for example from the group consisting of aniline, EDA, TDA, MDA and PMDA, more preferably from the group comprising TDA and PMDA, an most preferably TDA. When TDA is used, all isomers can be used alone or in any desired mixtures. For example, 2,4-TDA, 2,6-TDA, mixtures of 2,4-TDA and 2,6-TDA, 2,3-TDA, 3,4-TDA, mixtures of 3,4-TDA and 2,3-TDA, and also mixtures of all the above isomers can be used. Catalysts for the preparation of polyether polyols may include alkaline catalysts, such as potassium hydroxide, for anionic polymerization or Lewis acid catalysts, such as boron trifluoride, for cationic polymerization. Suitable polymerization catalysts may include potassium hydroxide, cesium hydroxide, boron trifluoride, or a double cyanide complex (DMC) catalyst such as zinc hexacyanocobaltate or quaternary phosphazenium compound. In a preferable embodiment of the present disclosure, the starting material polyether polyol includes polyethylene, (methoxy)polyethylene glycol (MPEG), polyethylene glycol (PEG), poly(propylene glycol), polytetramethylene glycol, poly(2-methyl-1,3-propane glycol) or copolymer of ethylene epoxide and propylene epoxide (polyethylene glycol-propylene glycol) with primary hydroxyl ended group or secondary hydroxyl ended group.

According to a preferable embodiment of the present disclosure, the amount of the polyisocyanate is properly selected so that the isocyanate group is present at a stoichiometric molar amount relative to the total molar amount of the hydroxyl groups included in the polyol and any additional additives or modifiers. According to an embodiment of the present disclosure, the polyurethane intermediate (PU main chain) has a NCO content of from 2 to 50 wt %, preferably from 6 to 49 wt %, preferably from 8 to 25 wt %, preferably from 10 to 20 wt %, more preferably from 11 to 15 wt %, most preferably from 12 to 13 wt %.

The reaction between the polyisocyanate and the polyol may occur in the presence of one or more catalysts that can promote the reaction between the isocyanate group and the hydroxyl group. Without being limited to theory, the catalysts can include, for example, glycine salts; tertiary amines; tertiary phosphines, such as trialkylphosphines and dialkylbenzylphosphines; morpholine derivatives; piperazine derivatives; chelates of various metals, such as those which can be obtained from acetylacetone, benzoylacetone, trifluoroacetyl acetone, ethyl acetoacetate and the like with metals such as Be, Mg, Zn, Cd, Pd, Ti, Zr, Sn, As, Bi, Cr, Mo, Mn, Fe, Co and Ni; acidic metal salts of strong acids such as ferric chloride and stannic chloride; salts of organic acids with variety of metals, such as alkali metals, alkaline earth metals, Al, Sn, Pb, Mn, Co, Ni and Cu; organotin compounds, such as tin(II) salts of organic carboxylic acids, e.g., tin(II) diacetate, tin(II) dioctanoate, tin(II) diethylhexanoate, and tin(II) dilaurate, and dialkyltin(IV) salts of organic carboxylic acids, e.g., dibutyltin diacetate, dibutyltin dilaurate, dibutyltin maleate and dioctyltin diacetate; bismuth salts of organic carboxylic acids, e.g., bismuth octanoate; organometallic derivatives of trivalent and pentavalent As, Sb and Bi and metal carbonyls of iron and cobalt; or mixtures thereof. In general, the content of the catalyst used herein is larger than zero and is at most 3.0 wt %, preferably at most 2.5 wt %, more preferably at most 2.0 wt %, based on the total weight of the component (A).

The silanizing agent used for introducing the silane group (especially, “R¹ₘ(R²O)₍₃₋ₘ₎Si—R⁷—”, “—R⁸—SiR³ₙ(R⁴O)₍₃₋ₙ₎” and “—R⁹—SiR⁵ₛ(R⁶O)₍₃₋ₛ₎”) into the SMP can be represented by a formula of silane-X, where the X group may be hydrogen, hydroxyl, amine group, imine group, isocyanate group, halogen atom (e.g. chlorine, bromine or iodine), ketoximato, amino, amido, acid amide, aminoxy, mercapto or alkenyloxy groups. Examples of suitable silanizing agent include γ-aminopropylmethyldimethoxysilane, γ-aminopropylmethyldiethoxysilane, γ-aminopropyltrimethoxysilane, γ-aminopropyltriethoxysilane, γ-aminophenyltrimethoxysilane, aminoethylaminopropyltrimethoxysilane, aminoethylaminopropyltriethoxysilane, aminoethyl aminoethylaminopropyltrimethoxysilane, aminoethylaminomethylmethyldiethoxysilane, (3-aminopropyl)-diethoxy-methylsilane, (3-aminopropyl)-dimethyl-ethoxysilane, (3-aminopropyl)-trimethoxysilane, N—((β-aminoethyl)-γ-aminopropyltriethoxysilane, 7-aminopropyldimethylmethoxysilane, N—((β-aminoethyl)-γ-aminopropyltrimethoxysilane, N-phenyl-γ-aminopropyltrimethoxysilane, (aminoethylaminomethyl)phenethyltrimethoxysilane, N—((β-aminoethyl)-γ-aminopropylmethyldimethoxysilane, N-(6-aminohexyl)-3-aminopropyl trimethoxysilane, N-(2-aminoethyl)-11-aminoundecyltrimethoxysilane, N—((β-aminoethyl)-γ-aminopropylethyldiethoxylsilane, and mixtures thereof.

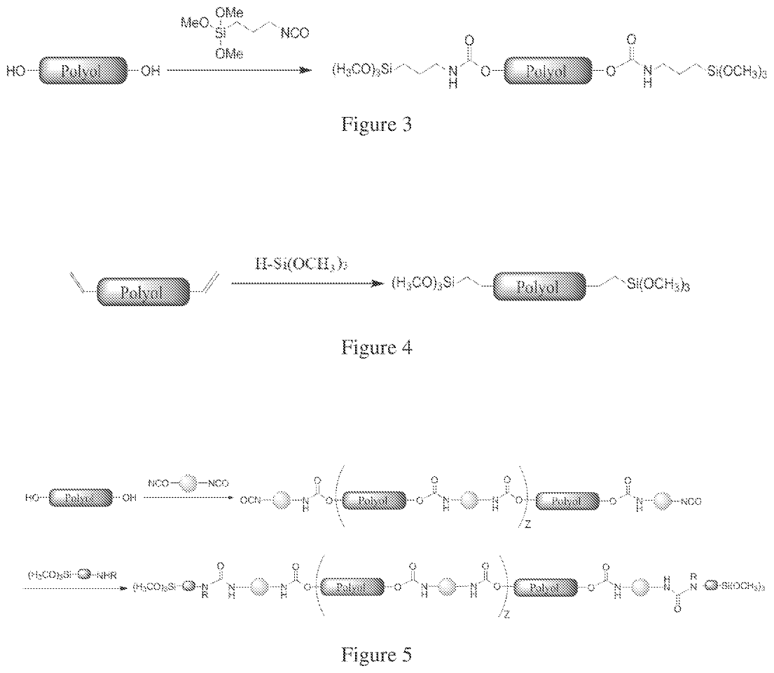

According to a preferable embodiment of the present disclosure, the polymeric main chain is solely derived from a polyol, and is preferably a polyether polyol or a polyester polyol. The polymeric main chain can be encapped with two or more terminal groups such as hydroxyl group, glycidyl group, allyl group, or combination thereof. A hydrosilylation reaction may occurs between the above stated terminal group of the polyol chain and the X group of the silanizing agent to form the SMP. The mechanical schemes of the silylation reaction and hydrosilylation reaction are shown in FIG. 3 and FIG. 4, in which the silanizing agent is isocyanate-propylene-Si(OCH₃)₃ and SiH(OCH₃)₃, respectively.

According to another preferable embodiment of the present disclosure, the polymeric main chain is a polyurethane main chain derived from the reaction of the polyisocyanate and the polyol. The polymeric main chain can be encapped with two or more terminal groups such as hydroxyl group or isocyanate group. A silylation reaction may occurs between the above stated terminal group of the polyurethane main chain and the X group of the silanizing agent to form the SMP. FIG. 5 illustrates the reaction mechanism of such a polyurethane-based SMP, wherein R shown in FIG. 5 represents a hydrogen atom or a C₁-C₆ alkyl group, and z is an integer from 5 to 5,000, or from 10 to 4,500, or from 30 to 4,300, or from 50 to 4,000, or from 80 to 3,800, or from 100 to 3,500, or from 200 to 3,000, or from 300 to 2,500, or from 400 to 2,000, or from 500 to 1,500, or from 600 to 1,200, or from 700 to 1,000, or from 800 to 900.

According to one embodiment of the present disclosure, the molar content of the silanizing agent is selected such that the SMP has a silane functionality of 1.2 to 4.0, preferably from 1.5 to 3.0, more preferably from 1.8 to 2.5, and more preferably from 2.0 to 2.2.

Generally, the amount of the SMP may vary based on the actual requirement of the resultant curable composition. For example, as one illustrative embodiment, the content of the SMP can be from 10 wt % to 70 wt %, or from 15 wt % to 70 wt %, or from 10 wt % to 65 wt %, or from 20 to 65 wt %, or from 20 wt % to 60 wt %, or from 12 wt % to 50 wt %, or from 14 to 40 wt %, or from 15 wt % to 30 wt %, or from 17 wt % to 25 wt %, or from 18 wt % to 24 wt %, or from 20 wt % to 24 wt %, based on the total weight of the curable composition.

The Epoxy Resin

In various embodiments of the present disclosure, the component (B) comprises an epoxy resin having at least one, preferably two epoxy terminal groups.

The epoxy resin can be any polymeric material containing epoxy functionality. The compound containing reactive epoxy functionality can vary widely, and it includes polymers containing epoxy functionality or a blend of two or more epoxy resins. The epoxy resin can be saturated or unsaturated, aliphatic, cycloaliphatic, aromatic or heterocyclic and can be substituted. In some embodiments, the epoxy resin can include a polyepoxide. Polyepoxide refers to a compound or mixture of compounds containing more than one epoxy moiety. Polyepoxides include partially advanced epoxy resins that is, the reaction product of a polyepoxide and a chain extender, wherein the reaction product has, on average, more than one unreacted epoxide unit per molecule. Aliphatic polyepoxides may be prepared from the reaction of epihalohydrins and polyglycols. Other specific examples of aliphatic epoxides include trimethylpropane epoxide, and diglycidyl-1,2-cyclohexane dicarboxylate. Other compounds include, epoxy resins such as, for example, the glycidyl ethers of polyhydric phenols (that is, compounds having an average of more than one aromatic hydroxyl group per molecule).

In one embodiment, the epoxy resins utilized in the curable composition of the present disclosure include those resins produced from an epihalohydrin and a phenol or a phenol type compound. The phenol type compound includes compounds having an average of more than one aromatic hydroxyl group per molecule. Examples of phenol type compounds include dihydroxy phenols, biphenols, bisphenols, halogenated biphenols, halogenated bisphenols, hydrogenated bisphenols, alkylated biphenols, alkylated bisphenols, trisphenols, phenol-aldehyde resins, novolac resins (which is the reaction product of phenols and simple aldehydes, such as formaldehyde), halogenated phenol-aldehyde novolac resins, substituted phenol-aldehyde novolac resins, phenol-hydrocarbon resins, substituted phenol-hydrocarbon resins, phenol-hydroxybenzaldehyde resins, alkylated phenol-hydroxybenzaldehyde resins, hydrocarbon-phenol resins, hydrocarbon-halogenated phenol resins, hydrocarbon-alkylated phenol resins, or combinations thereof. Specifically, phenol type compounds include resorcinol, catechol, hydroquinone, bisphenol A, bisphenol AP (1, 1-bis(4-hydroxyphenyl)-1-phenyl ethane), bisphenol F, bisphenol K, tetrabromobisphenol A, phenol-formaldehyde novolac resins, alkyl substituted phenol-formaldehyde resins, cresol-hydroxybenzaldehyde resins, dicyclopentadiene-phenol resins, dicyclopentadiene-substituted phenol resins, tetramethylbiphenol, tetramethyl-tetrabromobiphenol, tetramethyltribromobiphenol, and tetrachlorobisphenol A. In some embodiments the epoxy resins of the present compositions can have a functionality of at least 1.5, at least 3, or even at least 6.

In some embodiments, the epoxy resins utilized in the epoxy component (B) include those resins produced from an epihalohydrin and an amine. Suitable amines include diaminodiphenylmethane, aminophenol, xylene diamine, anilines, or combinations thereof.

In some embodiments, the epoxy resins utilized in the epoxy component include those resins produced from an epihalohydrin and a carboxylic acid. Suitable carboxylic acids include phthalic acid, isophthalic acid, terephthalic acid, tetrahydro- and/or hexahydrophthalic acid, endomethylenetetrahydrophthalic acid, isophthalic acid, methylhexahydrophthalic acid, or combinations thereof.

In some embodiments the epoxy resin is an advanced epoxy resin which is the reaction product of one or more epoxy resins, as described above, with one or more phenol type compounds and/or one or more compounds having an average of more than one aliphatic hydroxyl group per molecule. Alternatively, the epoxy resin may react with a carboxyl substituted hydrocarbon, which is a compound having a hydrocarbon backbone, preferably a C₁-C₄₀ hydrocarbon backbone, and one or more carboxyl moieties, preferably more than one, and most preferably two. The C₁-C₄₀ hydrocarbon backbone can be a straight- or branched-chain alkane or alkene, optionally containing oxygen. Fatty acids and fatty acid dimers are among the useful carboxylic acid substituted hydrocarbons. Included in the fatty acids are caproic acid, caprylic acid, capric acid, octanoic acid, decanoic acid, lauric acid, myristic acid, palmitic acid, stearic acid, palmitoleic acid, oleic acid, linoleic acid, linolenic acid, erucic acid, pentadecanoic acid, margaric acid, arachidic acid, and dimers thereof.

In some embodiments, the epoxy resin is the reaction product of a polyepoxide and a compound containing more than one isocyanate moiety or a polyisocyanate. For example, the epoxy resin produced in such a reaction can be an epoxy-terminated polyoxazolidone.

In one specific embodiment, the epoxy resin component is a blend of a brominated epoxy resin and a phenolic novolac epoxy resin.

According to various embodiments of the present application, the epoxy resin has a molecular weight of 100 to 20,000 grams per mole (g/mol), or from 500 to 15,000 g/mol, or from 800 to 12,000 g/mol, or from 1,000 to 10,000 g/mol, or from 2,000 to 9,000 g/mol, or from 3,000 to 8,000 g/mol, or from 4,000 to 7,000 g/mol, or from 5,000 to 6,000 g/mol. According to various embodiments of the present application, the epoxy resin has an epoxy functionality of 1.2 to 10, or from 2 to 9, or from 3 to 8, or from 4 to 7, or from 5 to 6. Generally, the amount of the epoxy resin may vary based on the actual requirement of the resultant curable composition. For example, as one illustrative embodiment, the content of the epoxy resin can be from 2.5 wt % to 65 wt %, or from 4 wt % to 65 wt %, or from 5 wt % to 65 wt %, or 6 wt % to 60 wt %, or from 7 wt % to 50 wt %, or from 8 wt % to 40 wt %, or from 9 to 30 wt %, or from 10 wt % to 25 wt %, or from 11 wt % to 24 wt %, or from 12 wt % to 22 wt %, or from 15 wt % to 22 wt %, or from 18 wt % to 22 wt %, based on the total weight of the curable composition.

Hardening Agent

According to one embodiment of the present application, the hardening agent is an essential component when the compatibilizer is a compound comprising at least one silane group and at least one epoxy terminal group. According to another embodiment of the present application, the hardening agent is an optional component, and is more preferably absent when the compatibilizer is a compound comprising at least one silane group and at least one nitrogen-containing group, e.g. amine group or imine group, in the same molecule.

According to various embodiments of the present disclosure, the hardening agent that can be used in the practice of this disclosure includes aliphatic amines, alicyclic amines, aromatic amines, polyaminoamides, imidazoles, dicyandiamides, epoxy-modified amines, Mannich-modified amines, Michael addition-modified amines, ketimines, acid anhydrides, alcohols and phenols, among others. According to a most preferable embodiment of the present application, the hardening agent is triethylene tetramine (TETA). As one illustrative embodiment, when the compatibilizer is a compound comprising at least one silane group and at least one epoxy terminal group, the hardening agent is an essential ingredient and the content of the hardening agent is from 0.1 to 8 wt %, or from 0.125 wt % to 7 wt %, or from 0.2 wt % to 6 wt %, or from 0.25 wt % to 5 wt %, or from 0.3 wt % to 4 wt %, or from 0.4 to 3 wt %, or from 0.5 wt % to 2.5 wt %, or from 0.6 wt % to 2 wt %, or from 0.7 wt % to 1 wt %, or from 0.75 wt % to 0.9 wt %, based on the total weight of the curable composition. The hardening agent can be either supplied and transmitted as a component independent from the component A and B, or contained in component B. According to a preferable embodiment of the present disclosure, the hardening agent is included in a component physically separated from the SMP and the epoxy resin. According to another preferable embodiment of the present disclosure, the hardening agent is included in a component comprising the two catalysts particularly selected for accelerating the curing procedure.

As another illustrative embodiment, when the compatibilizer is a compound comprising at least one silane group and at least one nitrogen-containing group (e.g. amine group and/or imine group), the hardening agent is an optional ingredient and the content of the hardening agent is zero, or from 0.1 to 8 wt %, or from 0.125 wt % to 7 wt %, or from 0.2 wt % to 6 wt %, or from 0.25 wt % to 5 wt %, or from 0.3 wt % to 4 wt %, or from 0.4 to 3 wt %, or from 0.5 wt % to 2.5 wt %, or from 0.6 wt % to 2 wt %, or from 0.7 wt % to 1 wt %, or from 0.75 wt % to 0.9 wt %, based on the total weight of the curable composition. When present, the hardening agent can be either supplied and transmitted as a component independent from the component A and B, or contained in component A. For example, the hardening agent can be included in the same component in which the compatibilizer comprising at least one silane group and at least one nitrogen-containing group (e.g. amine group and/or imine group), is contained.

Compatibilizer

The compatibilizer useful for the curable composition of the present disclosure is particularly characterized in that it comprises both the silane group as stated above and the epoxy group, which will be referred as the “epoxy-silane” or “epoxy-silane compatibilizer”, or has at least one silane group and at least one nitrogen-containing group, e.g. amine group or imine group, in the same molecule, which will be referred as the “amino-silane” or “amino-silane compatibilizer”. According to a preferable embodiment of the present disclosure, only one of the epoxy-silane compatibilizer and the amino-silane compatibilizer is selected for the curable composition.

According to an embodiment of the present disclosure, the epoxy-silane compatibilizer is represented by formula II, or can be a condensation oligomer or condensation polymer thereof:

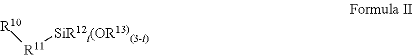

wherein R¹⁰ is selected a group consisting of

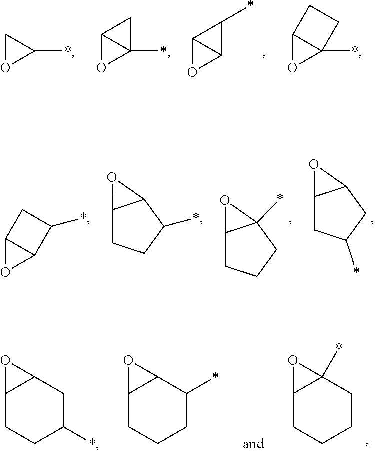

wherein * represents the linkage site where R¹⁰ is linked to the other moiety of the compatibilizer,

R¹¹ is selected from a group consisting of C₂-C₆ alkylene, —(CH₂—O)—C₂-C₆ alkylene, —C₂-C₆ alkylene-Si(C₁-C₆ alkyl)₂-C₂-C₆ alkylene, —(CH₂—O)—C₂-C₆ alkylene-Si(C₁-C₆ alkyl)₂-C₂-C₆ alkylene, —C₂-C₆ alkylene-Si(C₁-C₆ alkoxy)₂-C₂-C₆ alkylene, —(CH₂—O)—C₂-C₆ alkylene-Si(C₁-C₆ alkoxy)₂-C₂-C₆ alkylene, —(CH₂—O)—C₂-C₆ alkylene-Si(C₁-C₆ alkyl)₂-C₂-C₆ alkylene-(O—CH₂)—CH(OH)—CH₂—NH—C₂-C₆ alkylene, —(CH₂—O)—C₂-C₆ alkylene-Si(C₁-C₆ alkoxy)₂-C₂-C₆ alkylene-(O—CH₂)—CH(OH)—CH₂—NH—C₂-C₆ alkylene, —(CH₂—O)—C₂-C₆ alkylene-Si(C₁-C₆ alkyl)₂-[O—Si(C₁-C₆ alkyl)₂]ₓ-C₂-C₆ alkylene-(O—CH₂)—CH(OH)—CH₂—NH—C₂-C₆ alkylene, —(CH₂—O)—C₂-C₆ alkylene-Si(C₁-C₆ alkoxy)₂-[O—Si(C₁-C₆ alkoxy)₂]ₓ-C₂-C₆ alkylene-(O—CH₂)—CH(OH)—CH₂—NH—C₂-C₆ alkylene,

wherein each of R² and R¹³ independently represents a hydrogen atom or a C₁-C₆ alkyl group optionally substituted with C₁-C₆ alkyl group, C₁-C₆ alkoxy group, halogen atom, C₂-C₆ alkeny group, C₂-C₆ alkynyl group, —Si(C₁-C₄ alkyl)₄, —Si(C₁-C₄ alkoxy)₃, —Si—{O—[Si(C₁-C₄alkoxy)₄]₃, —(C₁-C₆)alkylene-Si(C₁-C₄ alkyl)₃, —(C₁-C₆)alkylene —Si(C₁-C₄ alkoxy)₃ or —(C₁-C₆)alkylene-Si—{O—[Si(C₁-C₄ alkoxy)₃]₃,

t represents an integer of 0, 1 or 2, and x represents an integer of 1 to 100. For example, x can be an integer of 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100.

As indicated herein, the term “condensation oligomer” and “condensation polymer” refers to an oligomeric or polymeric compound obtained by condensing two or more compound represented by Formula II, and especially via the condensation of silane group. For example, the compatibilizer can be a condensation oligomer or condensation polymer represented by formula III,

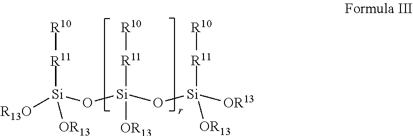

wherein R¹⁰, R¹¹ and R¹³ are as stated above, and r represents an integer of 1 to 50, such as an integer of 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49 or 50.

According to a most preferable embodiment of the present disclosure, the epoxy-silane compatibilizer is selected from any one of the following compounds:

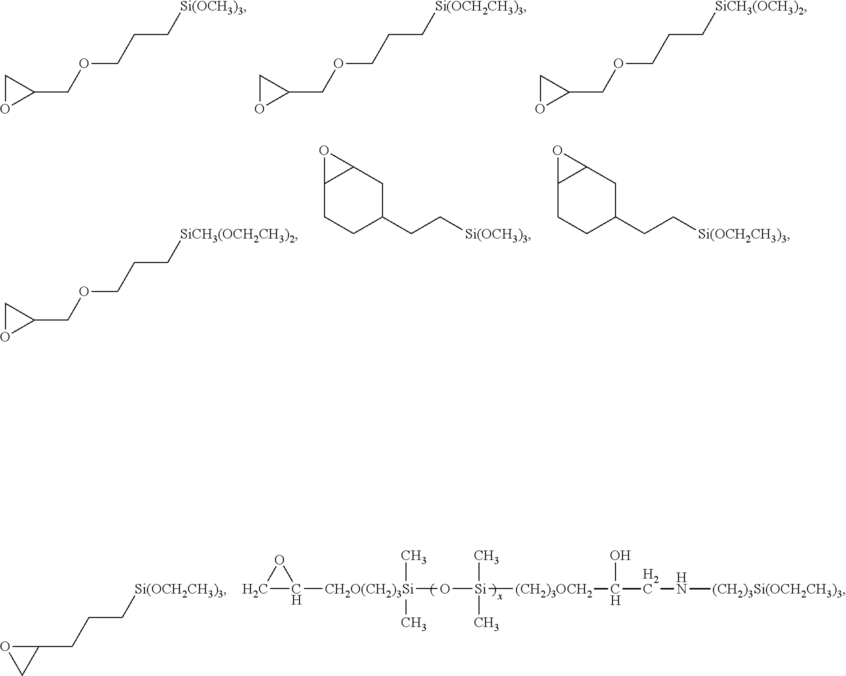

wherein x represents an integer of 1 to 100, such as an integer of an integer of 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100,

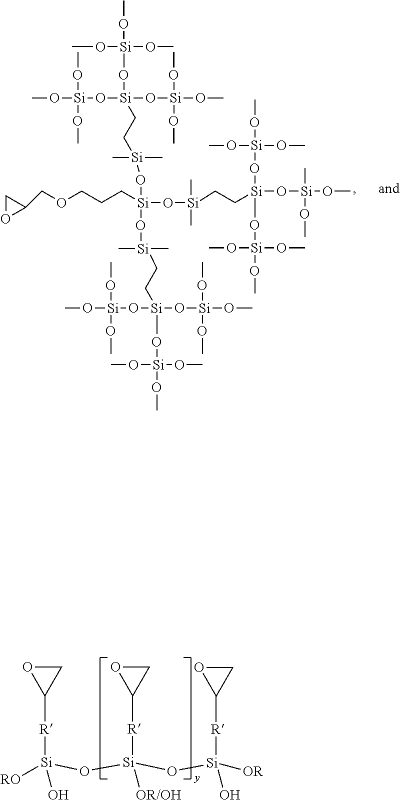

wherein R′ is selected from a group consisting of C₂-C₆ alkylene, —(CH₂—O)—C₂-C₆ alkylene, —C₂-C₆ alkylene-Si(C₁-C₆ alkyl)₂-C₂-C₆ alkylene, —(CH₂—O)—C₂-C₆ alkylene-Si(C₁-C₆ alkyl)₂-C₂-C₆ alkylene, —C₂-C₆ alkylene-Si(C₁-C₆ alkoxy)₂-C₂-C₆ alkylene, —(CH₂—O)—C₂-C₆ alkylene-Si(C₁-C₆ alkoxy)₂-C₂-C₆ alkylene, —(CH₂—O)—C₂-C₆ alkylene-Si(C₁-C₆ alkyl)₂-C₂-C₆ alkylene-(O—CH₂)—CH(OH)—CH₂—NH—C₂-C₆ alkylene, —(CH₂—O)—C₂-C₆ alkylene-Si(C₁-C₆ alkoxy)₂-C₂-C₆ alkylene-(O—CH₂)—CH(OH)—CH₂—NH—C₂-C₆ alkylene, —(CH₂—O)—C₂-C₆ alkylene-Si(C₁-C₆ alkyl)₂-[O—Si(C₁-C₆ alkyl)₂]ₓ—C₂-C₆ alkylene-(O—CH₂)—CH(OH)—CH₂—NH—C₂-C₆ alkylene, —(CH₂—O)—C₂-C₆ alkylene-Si(C₁-C₆ alkoxy)₂-[O—Si(C₁-C₆ alkoxy)₂]ₓ—C₂-C₆ alkylene-(O—CH₂)—CH(OH)—CH₂—NH—C₂-C₆ alkylene, R represents a hydrogen atom or a C₁-C₆ alkyl group optionally substituted with C₁-C₆ alkyl group, C₁-C₆ alkoxy group, halogen atom, C₂-C₆ alkeny group, C₂-C₆ alkynyl group, —Si(C₁-C₄ alkyl)₃, —Si(C₁-C₄ alkoxy)₃, —Si—{O—[Si(C₁-C₄alkoxy)₃]₃, —(C₁-C₆)alkylene-Si(C₁-C₄ alkyl)₃, —(C₁-C₆)alkylene —Si(C₁-C₄ alkoxy)₃ or —(C₁-C₆)alkylene-Si—{O—[Si(C₁-C₄ alkoxy)₃]₃, and y represents an integer of 1 to 50, such as an integer of 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49 or 50.

As one illustrative embodiment, the content of the epoxy-silane compatibilizer is from 0.5 wt % to 15 wt %, or from 0.6 wt % to 14 wt %, or from 0.7 wt % to 13 wt %, or from 0.8 to 12 wt %, or from 0.9 wt % to 11 wt %, or from 1 wt % to 10 wt %, or from 1.1 wt % to 9 wt %, or from 1.2 wt % to 8 wt %, or from 1.25 wt % to 7 wt %, or from 1.3 wt % to 6 wt %, or from 1.2 wt % to 5 wt %, or from 1.2 wt % to 4 wt %, or from 1.2 wt % to 3 wt %, or from 1.2 wt % to 2 wt %, or from 1.2 wt % to 1.75 wt %, or from 1.2 wt % to 1.5 wt %, based on the total weight of the curable composition. The epoxy-silane compatibilizer can be either supplied and transmitted as a component independent from the component A and B, or contained in component A, or being supplied and transmitted as a blend with the SMP, the epoxy resin, or both. According to a preferable embodiment of the present disclosure, the hardening agent is contained in component A, i.e. as a blend with the SMP, the epoxy resin and any optional additives.

According to an embodiment of the present disclosure, the amino-silane compatibilizer is a compound represented by formula IV:

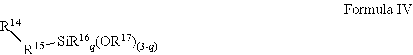

wherein R¹⁴ is selected a group consisting of NH₂—, pyridinyl, pyrryl, NH₂(C₁-C₆ alkylene)-, NH₂(C₁-C₆ alkylene)-NH—, NH₂(C₁-C₁₀ alkylene-O)—NH—, (NH₂)₂CH—, (NH₂)₃C—, (NH₂—C₁-C₆ alkylene)₂ CH—, (NH₂—C₁-C₆ alkylene)₃C—, (NH₂)₂CH(C₁-C₆ alkylene)-, (NH₂)₃C(C₁-C₆ alkylene)-, (NH₂—C₁-C₆ alkylene)₂CH(C₁-C₆ alkylene)-, (NH₂—C₁-C₆.alkylene)₃C(C₁-C₆ alkylene)-, phenylNH—, (C₁-C₆alkyl)NH—, (C₁-C₆alkyl)₂N—, (C₁-C₆cycloalkyl)NH—, (C₁-C₆cycloalkyl)₂N—, (C₁-C₆alkenyl)NH—, (C₁-C₆alkenyl)₂N—, (hydroxyC₁-C₆alkyl)NH—, (hydroxyC₁-C₆alkyl)₂N—;

R¹⁵ is selected from a group consisting of a direct bond, phenylene, —(C₁-C₆ alkylene)-, phenylene-(C₁-C₆ alkylene)-, —NH—(C₁-C₆ alkylene)-, —NH—NH—(C₁-C₆ alkylene)-, —NH—(C₁-C₆ alkylene)-NH—, —NH—(C₁-C₆ alkylene)-NH—(C₁-C₆ alkylene)- and —NH—(C₁-C₆ alkylene)-NH—(C₁-C₆ alkylene)-NH—; wherein each of R¹⁶ and R¹⁷ independently represents a hydrogen atom or a C₁-C₆ alkyl group optionally substituted with C₁-C₆ alkyl group, C₁-C₆ alkoxy group, —(C₁-C₆)alkylene-O—C₁-C₆ alkyl group, —(C₁-C₆)alkylene-O—(C₁-C₆)alkylene-O—C₁-C₆ alkyl group, halogen atom, C₂-C₆ alkeny group, C₂-C₆ alkynyl group, —Si(C₁-C₄ alkyl)₃, —Si(C₁-C₄ alkoxy)₃, —Si—{O—[Si(C₁-C₄alkoxy)₃]3, —(C₁-C₆)alkylene-Si(C₁-C₄ alkyl)₃, —(C₁-C₆)alkylene —Si(C₁-C₄ alkoxy)₃ or —(C₁-C₆)alkylene-Si—{O—[Si(C₁-C₄ alkoxy)₃]₃; wherein q represents an integer of 0, 1 or 2; and with the proviso that there are at least two nitrogen atoms in the compound represented by formula IV. It shall be particularly noted that the amino-silane compatibilizer may comprise at least one primary amine group, or at least two secondary amine groups, or one or more primary amine group and at least one secondary amine group, or a combination thereof. According to the embodiments of the present disclosure, the nitrogen-containing group contained in this compatibilizer can be amino, amine, imine, pyridinyl or pyrryl, but this compatibilizer represented by formula IV can still be referred as “amino-silane” as all the nitrogen atoms in the different nitrogen-containing groups exhibit similar chemical function and property as those of amino group.

According to an embodiment of the present disclosure, the amino-silane compatibilizer is selected from a group consisting of

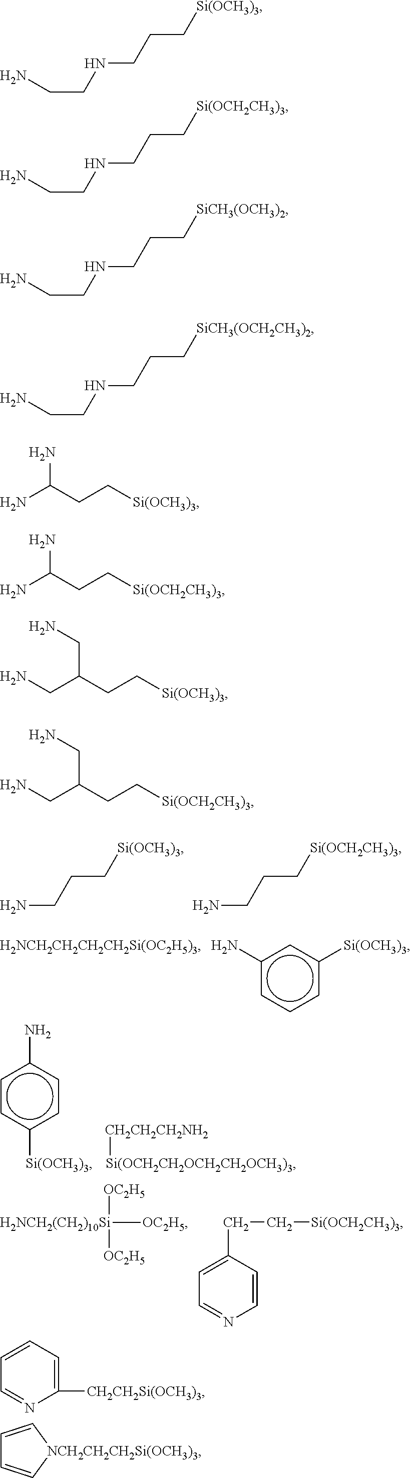

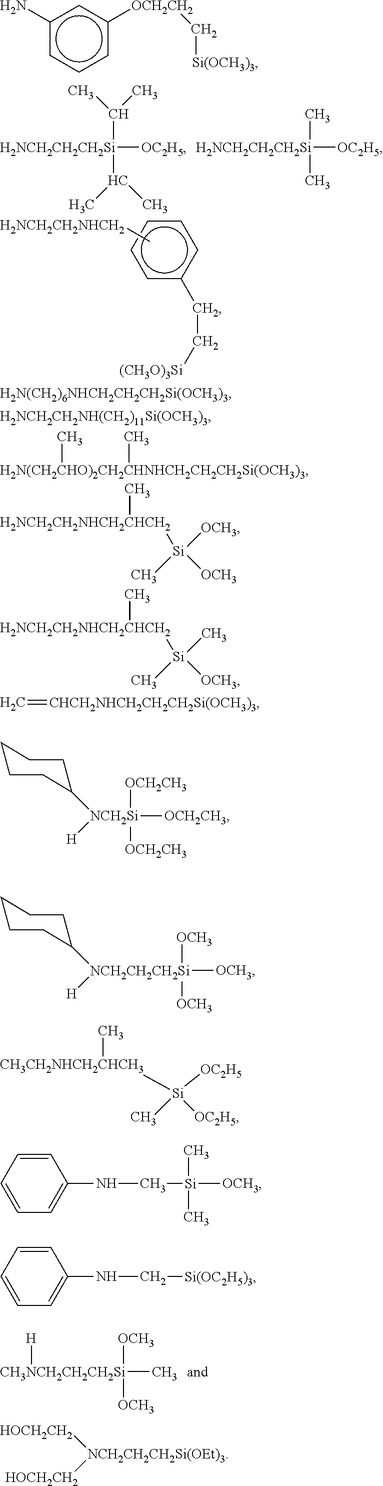

As one illustrative embodiment, wherein the content of the amino-silane compatibilizer represented by formula IV is from 0.5 wt % to 20 wt %, or from 0.8 wt % to 18 wt %, or from 1 wt % to 16 wt %, or from 1.2 to 14 wt %, or from 1.5 wt % to 12 wt %, or from 2 wt % to 10 wt %, or from 2.5 wt % to 9 wt %, or from 3 wt % to 8.8 wt %, or from 3.5 wt % to 8.5 wt %, or from 4 wt % to 8 wt %, or from 4.5 wt % to 7.5 wt %, or from 5 wt % to 7 wt %, or from 5.5 wt % to 6.5 wt %, or from 5.5 wt % to 6 wt %, based on the total weight of the curable composition.

The amino-silane compatibilizer can be either supplied and transmitted as a component independent from the component A and B, or contained in component A or B. According to a preferable embodiment of the present disclosure, the amino-silane compatibilizer is contained in component A, i.e. as a blend with the SMP.

According to preferable embodiments of the present disclosure, the amounts of the SMP, the epoxy resin and the amino-silane compatibilizer are particularly selected so that the molar ratio of total amine functionality to total epoxy functionality could be in the range of 0.8:1 to 4:1; or from 0.9:1 to 3:1; or from 1.0:1 to 2.5:1; or from 1.1:1 to 2.0:1; or from 1.2:1 to 1.4:1.

Cure-Promoting/Accelerating Catalyst

Without being limited to any specific theories, one technical breakthrough of the present disclosure resides in the incorporation of two catalysts in the curable composition for enhancing the curing speed, and these two catalysts will also be referred as cure-promoting/accelerating catalyst so as to distinguish them from the other catalysts for, e.g. catalyzing the preparation of polyurethane and the epoxy resin.

One of the cure-promoting/accelerating catalysts is a nitrogen-containing unsaturated heterocyclic compound catalyst. Preferably, the nitrogen-containing unsaturated heterocyclic compound catalyst comprises at least two nitrogen atoms and at least two heterocyclic groups. More preferably, the nitrogen-containing unsaturated heterocyclic compound catalyst is selected from the group consisting of 1,8-diazabicyclo[5.4.0]undec-7-ene, 1,5-diazabicyclo[4.3.0]non-5-ene, 2,3-diazabicyclo[2.2.0] hex-1-ene and 1,3-diazabicyclo[3.1.0]hex-3-ene. Most preferably, the nitrogen-containing unsaturated heterocyclic compound catalyst is 1,8-diazabicyclo[5.4.0]undec-7-ene (DBU).

The nitrogen-containing unsaturated heterocyclic compound catalyst can be either supplied and transmitted as an component independent from the component A and B, or contained in component B. According to a preferable embodiment of the present disclosure, the compatibilizer is an epoxy-silane compatibilizer, and the nitrogen-containing unsaturated heterocyclic compound catalyst is included in a component physically separated from the epoxy-silane compatibilizer or epoxy resin. According to another preferable embodiment of the present disclosure, the nitrogen-containing unsaturated heterocyclic compound catalyst is included in a component comprising the hardening agent, the other cure-promoting/accelerating catalyst, and any optional additives.

As one illustrative embodiment, when the compatibilizer is an epoxy-silane compatibilizer, the content of the nitrogen-containing unsaturated heterocyclic compound catalyst is from 0.5 to 20 wt %, or from 0.55 wt % to 15 wt %, or from 0.6 wt % to 10 wt %, or from 0.65 wt % to 8 wt %, or from 0.7 wt % to 7 wt %, or from 0.75 to 6 wt %, or from 0.8 wt % to 5 wt %, or from 0.9 wt % to 4 wt %, or from 1 wt % to 3 wt %, or from 1.1 wt % to 2 wt %, or from 1.2 wt % to 1.8 wt %, or from 0.75 wt % to 1.5 wt %, based on the total weight of the curable composition.

According to another illustrative embodiment, when the compatibilizer is an amino-silane compatibilizer, and the nitrogen-containing unsaturated heterocyclic compound catalyst is an optional ingredient contained as a mixture with the SMP. As one illustrative embodiment, when the compatibilizer is an amino-silane compatibilizer, the content of the nitrogen-containing unsaturated heterocyclic compound catalyst is zero, or from 0 to 20 wt %, or from 0.05 wt % to 15 wt %, or from 0.08 wt % to 10 wt %, or from 0.1 wt % to 8 wt %, or from 0.2 wt % to 7 wt %, or from 0.25 to 6 wt %, or from 0.28 wt % to 5 wt %, or from 0.3 wt % to 4 wt %, or from 0.35 wt % to 3 wt %, or from 0.4 wt % to 2 wt %, or from 0.45 wt % to 1.8 wt %, or from 0.5 wt % to 1.5 wt %, based on the total weight of the curable composition.

The other one of the cure-promoting/accelerating catalysts is a nitrogen-containing phenol catalyst. Preferably, the nitrogen-containing phenol catalyst comprises at least one amino group. More preferably, the nitrogen-containing phenol catalyst is selected from the group consisting of 2,4,6-tris(R₀)phenol, 2,4-bis(R₀)phenol, 2,3-bis(R₀)phenol, 3,4-bis(R₀)phenol, 2,6-bis(R₀)phenol, 2,5-bis(R₀)phenol and 3,5-bis(R₀)phenol, wherein each R₀ is independently selected from the group consisting of amino(C₁-C₆)alkyl, (C₁-C₆)alkylamino(C₁-C₆)alkyl and di(C₁-C₆)alkylamino(C₁-C₆)alkyl. Most preferably, the nitrogen-containing phenol catalyst is 2,4,6-Tris (dimethylaminomethyl)phenol (DMP-30).

As one illustrative embodiment, the compatibilizer is an epoxy-silane compatibilizer, and the nitrogen-containing phenol catalyst is an essential ingredient. The nitrogen-containing phenol catalyst can be either supplied and transmitted as an component independent from the component A and B, or contained in component B. According to a preferable embodiment of the present disclosure, the nitrogen-containing phenol catalyst is included in a component physically separated from epoxy functionalized compatibilizer or the epoxy resin. According to another preferable embodiment of the present disclosure, the nitrogen-containing phenol catalyst is included in a component comprising the hardening agent, the other cure-promoting/accelerating catalyst, and any optional additives.

As one illustrative embodiment, the content of the nitrogen-containing phenol catalyst is from 0.001 to 5 wt %, or from 0.002 wt % to 4 wt %, or from 0.005 wt % to 3 wt %, or from 0.007 wt % to 2 wt %, or from 0.080 wt % to 1.5 wt %, or from 0.010 to 1.25 wt %, or from 0.012 wt % to 1 wt %, or from 0.015 wt % to 0.75 wt %, or from 0.017 wt % to 0.6 wt %, or from 0.020 wt % to 0.5 wt %, or from 0.022 wt % to 0.4 wt %, or from 0.025 wt % to 0.3 wt %, based on the total weight of the curable composition.

Water

According to a preferable embodiment of the present disclosure, the curable composition of the present disclosure is water free, i.e. no water or moisture is intentionally incorporated therein. In other words, the water-free curable composition of the present disclosure may comprise trace amount of moisture introduced by one or more of the raw materials or the atmosphere. For example, the water-free curable composition of the present disclosure may have a water amount (as impurity) lower than 500 ppm, or lower than 400 ppm, or lower than 300 ppm, or lower than 100 ppm, or lower than 50 ppm, or lower than 10 ppm, or lower than 5 ppm, or lower than 1 ppm, or lower than 500 ppb, or lower than 100 ppb, or lower than 50 ppb, or lower than 10 ppb, or lower than 5 ppb, or lower than 1 ppb.

According to another preferable embodiment of the present disclosure, the curable composition of the present disclosure is a water-based system and comprises water intentionally added, preferably added in component B. Without being limited to any specific theories, it is estimated that water is used as a promoter for accelerating the curing procedure. For example, the water-based curable composition of the present disclosure may have a water amount from 0.1 wt % to 6 wt %, or from 0.2 wt % to 5.5 wt %, or from 0.5 wt % to 4 wt %, or from 0.6 wt % to 3.8 wt %, or from 0.65 wt % to 3.5 wt %, or from 0.68 to 3.2 wt %, or from 0.7 wt % to 3 wt %, or from 0.72 wt % to 2.8 wt %, or from 0.74 wt % to 2.6 wt %, or from 0.75 wt % to 2 wt %, or from 0.8 wt % to 1.5 wt %, or from 0.9 wt % to 1.2 wt %, or from 1.0 wt % to 1.1 wt % based on the total weight of the curable composition.

Additives

In various embodiments of the present disclosure, the curable composition may further comprises one or more additives selected from the group consisting of catalyst other than the above stated cure-promoting/accelerating catalyst, including those for catalyzing the preparation of polyurethane, polyester polyol, or the reactions among the SMP, epoxy resin, hardening agent and compatibilizer; moisture scavengers, such as vinyl-Si[O—(C₁-C₄)alkyl], especially vinyltrimethoxysilane; chain extenders; crosslinkers; tackifiers; plasticizers, such as phthalic acid esters, non-aromatic dibasic acid esters and phosphoric esters, polyesters of dibasic acids with a dihydric alcohol, polypropylene glycol and its derivatives, polystyrene; rheology modifiers; antioxidants, such as liquid sterically hindered phenolic antioxidant; fillers, such as calcium carbonate, kaolin, talc, silica, titanium dioxide, aluminum silicate, magnesium oxide, zinc oxide and carbon black; colorants; pigments; surfactants; solvents, such as hydrocarbons, acetic acid esters, alcohols, ethers and ketones; diluents; flame retardants; slippery-resistance agents; antistatic agents; preservatives; biocides; UV stabilizers; thixotropes; anti-sagging agents, such as hydrogenated castor oil, organic bentonite, calcium stearate; light stabilizer, such as liquid hindered amine light stabilizer; and combinations of two or more thereof. These additives are used in known ways and amounts. These additives can be transmitted and stored as independent components and incorporated into the curable composition shortly or immediately before the combination of components (A) and (B). Alternatively, these additives may be contained in either of components (A) and (B) when they are chemically inert to the reactive groups such as epoxy group, amino group and silane group.

The above stated catalyst other than the cure-promoting/accelerating catalyst refers to a catalytic substance which may further enhance the interaction between the reactive groups such as epoxy group, amino group and silane group. It is also known as curing catalyst and can be used each independently or in a combination of two or more species. Representative catalysts include dimethyltin dineodecanoate, dibutyltin dilaurate, dibutyltin acetoacetate, titanium acetoacetate, titanium ethyl acetoacetate complex and tetraisopropyl titanate, bismuth carboxylate, zinc octoate, blocked tertiary amines, zirconium complexes, and combinations of amine and Lewis acid catalysts adducts of tin compositions and silicic acid. According to a preferable embodiment of the present disclosure, the amount of the above stated catalyst other than the cure-promoting/accelerating catalyst is 0.01-20 wt %, or 0.02-15 wt %, or 0.03-10 wt %, or 0.04-8 wt %, or 0.05-6 wt %, or 0.06-5 wt %, or 0.07-4 wt %, or 0.07-3 wt %, or 0.08-2 wt %, or 0.09-1 wt %, or 0.1-0.8 wt %, based on the total weight of the curable composition.

According an embodiment of the present disclosure, the curable composition of the present disclosure only comprises the epoxy-silane compatibilizer and does not comprise the amino-silane compatibilizer. According another preferable embodiment of the present disclosure, the curable composition of the present disclosure only comprises the amino-silane compatibilizer and does not comprise the epoxy-silane compatibilizer.

One combined, the silane modified polymer, epoxy resin, the optional hardening agent and compatibilizer react with each other in the presence of the optional cure-promoting/accelerating catalysts and rapidly cure to form the target layer or structure. The curing process may be carried out, for example, under a temperature of 0° C. or higher, preferably 10° C. or higher, more preferably 20° C. or higher, more preferably from 15° C. to 30° C., at the same time 300° C. or lower, preferably 100° C. or lower, more preferably 50° C. or lower and more preferably 40° C. or lower. The curing process may be carried out, for example, at a pressure of desirably 0.01 bar or higher, preferably 0.1 bar or higher, more preferably 0.5 bar or higher, more preferably 0.9 bar or higher and at the same time desirably 1000 bar or lower, preferably 100 bar or lower, more preferably 10 bar or lower, more preferably 5 bar or lower, more preferably 1.5 bar or lower. According to an exemplary embodiment of the present disclosure, the curing process is conducted under ambient temperature and pressure. The curing process may be carried out for a predetermined period of time sufficient to cure the SMP-epoxy composition. For example, the curing time may be desirably within two hours, or within one hour, or within 50 minutes, or within 40 minutes, or within 30 minutes, or within 20 minutes, or within 15 minutes, or within 10 minutes, or within 5 minutes, or within 3 minutes.

The uncured blend of the component A and component B may be applied to one or more substrates by a batch or a continuous process. The uncured blend may be applied by technologies such as gravity casting, vacuum casting, automatic pressure gelation (APG), vacuum pressure gelation (VPG), infusion, filament winding, injection (for example, lay up injection), transfer molding, prepreging, dipping, coating, potting, encapsulation, spraying, brushing, and the like.

According to an embodiment of the present disclosure, the curable composition is a two-component composition comprising: component (A) comprising 35-80 wt % SMP, 5-70 wt % epoxy resin, 1-10 wt % epoxy-silane compatibilizer, 0.1-1.5 wt % catalyst other than the cure-promoting/accelerating catalyst, and balance amount of additives, based on the total weight of component A; and component (B) comprising 0.5-5 wt % nitrogen-containing unsaturated heterocyclic compound catalyst, 0.05-1 wt % nitrogen-containing phenol catalyst, 0.5-4 wt % hardening agent, 0-10 wt % water, and balance amount of additives, based on the total weight of component B; and the weight ratio between the component A and component B is from 1:5 to 5:1, or from 1:2 to 2:1, or from 1.1:1 to 1:1.1, such as 1:1.

Preferably, the curable composition is a two-component composition comprising: component (A) comprising 35-80 wt % SMP, 5-70 wt % epoxy resin, 1-10 wt % epoxy-silane compatibilizer, 0.1-1.5 wt % catalyst other than the cure-promoting/accelerating catalyst, 0-30 wt % filler, 0.2-1.5 wt % moisture scavenger, 0-30 wt % plasticizer, 0-10 wt % pigment, 0-1 wt % antioxidant, 0-1 wt % light stabilizer, 0-5 wt % thixitrope agent, based on the total weight of component A; and component (B) comprising 0.5-5 wt % nitrogen-containing unsaturated heterocyclic compound catalyst, 0.05-1 wt % nitrogen-containing phenol catalyst, 0.5-4 wt % hardening agent, 0-6 wt % water, 0-60 wt % plasticizer, 0-60 wt % filler and 0-5 wt % pigment, based on the total weight of component B; and the weight ratio between the component A and component B is from 1:5 to 5:1, or from 1:2 to 2:1, or from 1.1:1 to 1:1.1, such as 1:1.

According to another embodiment of the present disclosure, the curable composition is a two-component composition comprising: Component (A) comprising 35-80 wt % SMP, 5-70 wt % epoxy resin, 1-10 wt % epoxy-silane compatibilizer, 0.1-1.5 wt % catalyst other than the cure-promoting/accelerating catalyst, and balance amount of additives, based on the total weight of component A; Component (B) comprising 0.5-5 wt % nitrogen-containing unsaturated heterocyclic compound catalyst, 0.05-1 wt % nitrogen-containing phenol catalyst, 0.5-4 wt % hardening agent, 0-6 wt % water and balance amount of additives, based on the total weight of component B; and the weight ratio between the component A and component B is from 1:5 to 5:1, or from 1:2 to 2:1, or from 1.1:1 to 1:1.1, such as 1:1.

Preferably, the curable composition is a two-component composition comprising: component (A) comprising 35-80 wt % SMP, 5-70 wt % epoxy resin, 1-10 wt % epoxy-silane compatibilizer, 0.1-1.5 wt % catalyst other than the cure-promoting/accelerating catalyst, 0-30 wt % filler, 0.2-1.5 wt % moisture scavenger, 0-30 wt % plasticizer, 0-10 wt % pigment, 0-1 wt % antioxidant, 0-1 wt % light stabilizer, 0-5 wt % thixitrope agent, based on the total weight of component A; and component (B) comprising 0.5-5 wt % nitrogen-containing unsaturated heterocyclic compound catalyst, 0.05-1 wt % nitrogen-containing phenol catalyst, 0.5-4 wt % hardening agent, 0-60 wt % plasticizer, 0-60 wt % filler, 0-5 wt % pigment and 0-6 wt % water, based on the total weight of component B; and the weight ratio between the component A and component B is from 1:5 to 5:1, or from 1:2 to 2:1, or from 1.1:1 to 1:1.1, such as 1:1.

According to another embodiment of the present disclosure, the curable composition is a two-component composition comprising: Component (A) comprising 10-90 wt % SMP, 1-20 wt % amino-silane compatibilizer, 0-10 wt %, preferably 0-3 wt % nitrogen-containing unsaturated heterocyclic compound catalyst, and balance amount of additives, based on the total weight of component A; Component (B) comprising 1-70 wt %, preferably 1-50 wt % epoxy resin, 0.1-6 wt % catalyst other than the cure-promoting/accelerating catalyst (e.g. tin-containing catalyst, and particularly dimethyltin dineodecanoate), and balance amount of additives, based on the total weight of component B; and the weight ratio between the component A and component B is from 1:5 to 5:1, or from 1:2 to 2:1, or from 1.1:1 to 1:1.1, such as 1:1.

Preferably, the curable composition of the present disclosure has a nitrogen (e.g. the total molar amount of amine, amino, imine, pyridinyl and pyrryl group) to epoxy ratio by mole of 0.7 to 1.8, preferably from 0.8 to 1.5, more preferably 0.9 to 1.3. According to another embodiment of the present disclosure, the weight ratio of SMP to epoxy resin is from 6/1 to 1/3, preferably from 5/1 to 1/1.

Preferably, the curable composition is a two-component composition comprising: component (A) comprising 10-90 wt % SMP, 1-20 wt % amino-silane compatibilizer, 0-3 wt % nitrogen-containing unsaturated heterocyclic compound catalyst, 0.1-2 wt % moisture scavenger (such as VTMS), 0-50 wt % filler, 0-30 wt % plasticizer (such as DINP), 0-5 wt % thixitrope agent (such as SLT), 0-1 wt % antioxidant (such as Irganox 1135), 0-1 wt % light stabilizer (such as Tinuvin 765), 0-10 wt % pigment (such as TiO₂), based on the total weight of component A; and component (B) comprising 1-50 wt % epoxy resin, 0.1-6 wt % catalyst other than the cure-promoting/accelerating catalyst (such as DMT), 0-60 wt % plasticizer (such as DINP), 0-60 wt % filler, 0-1 wt % pigment, based on the total weight of component B; and the weight ratio between the component A and component B is from 10:1 to 1:10, or from 1:5 to 5:1, or from 1:2 to 2:1, or from 1.1:1 to 1:1.1, such as 1:1.

According to another preferable embodiment of the present application, the weight ratio between SMP and epoxy resin is from 20:1 to 1:10, or from 15:1 to 1:8, or from 10:1 to 1:7, or from 8:1 to 1:6, or from 7:1 to 1:5, or from 6:1 to 2:9, or from 5:1 to 2:9, or from 3:1 to 2:9, or from 2:1 to 2:9, or from 1:1 to 2:9, or from 1:2 to 2:9, or from 1:3 to 2:9.

According to a preferable embodiment of the present disclosure, the curable composition of the present disclosure at least exhibit the following performance properties: can be dried very fast (e.g. having a skin formation time of less than 20 minutes, such as less than 18 minutes, or less than 15 minutes, or less than 13 minutes, or less than 12 minutes, or less than 10 minutes, or less than 8 minutes, or less than 6 minutes, or less than 5 minutes, or less than 3 minutes); achieve an acceptable hermeticity; pass anti-fog testing of e.g. 96 hours; quick adhesion build-up (can achieve acceptable adhesion strength after 24 hours, or 20 hours, or 16 hours, or 12 hours, or 10 hours, or 8 hours, or 6 hours, or 4 hours, or 2 hours, or 1 hours, or 30 minutes, or 20 minutes); and high adhesion (e.g. exhibiting a lap shear strength of larger than 0.5 MPa after 1 hour, larger than 1.5 MPa after 6 hours, larger than 2.5 MPa after 24 hours, larger than 2 MPa or larger than 3 MPa after one week).

### Examples

Some embodiments of the invention will now be described in the following Examples. However, the scope of the present disclosure is not, of course, limited to the formulations set forth in these examples. Rather, the Examples are merely an illustration of the disclosure.

The information of the raw materials used in the examples is listed in the following table 1:

TABLE 1
Raw materials used in the examples

| Product name | Structure | Function | Supplier |
|---|---|---|---|
| Voranol ™ 4000LM | Linear PO polyol (diol) | Polyol | Dow Chemical |
| IPDI | 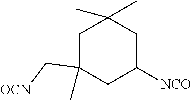 | Isocyanate | SCRC |
| D.E.R. ™ 383 | Bisphenol A epoxy resin | Epoxy resin | Dow Chemical |
| SCA-3303 | 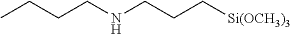 | Capping agent | Guotai Huarong |
| SPUR+ 1015LM | Silane modified polyurethane | SMP | Momentive |
| SPUR⁺ 1050LM | Silane modified polyurethane | SMP | Momentive |
| TETA | 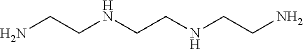 | Hardening agent | SCRC |
| Jeffamine D230 | 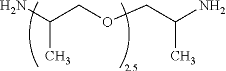 | Hardening agent | Huntsman |
| DINP | 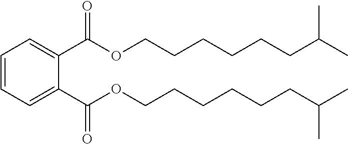 [SMILES: CC(C)CCCCCCOC(=O)c1ccccc1C(=O)OCCCCCCC(C)C] | Plasticizer | Exxon Mobil Corporation |
| KH ™560 | 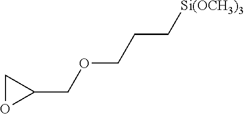 | Compatibilizer | Dow Chemical |
| Z-6020 | 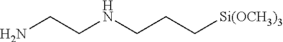 | Hardening compatibilizing agent | DOW Chemical |
| XTCC-201 | Surface treated precipitated calcium | Reinforcing | Jiangxi Xintai |
| | carbonate | filler | Chemical |
| VTMS ™ | 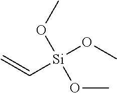 | Moisture scavenger | DOW Chemical |
| DMT | Dimethyltin dineodecanoate | Catalyst | SEHOTECH |
| | | | INC |
| DBU | 1,8-diazabicyclo[5.4.0]undec-7 ene | cure- | Sigma-Aldrich |
| | | promoting/ | |
| | | accelerating | |
| | | catalyst | |
| DMP-30 | 2,4,6-Tris(dimethylaminomethyl) | cure- | Sigma-Aldrich |
| | phenol | promoting/ | |
| | | accelerating | |
| | | catalyst | |
| R 706 | TiO₂ | Pigment | DuPont |
| Carbon black 611 | Carbon | Pigment | Degussa |
| Irganox 1135 | Liquid sterically hindered phenolic | Antioxidant | BASF |
| | antioxidant | | |
| Tinuvin 765 | Liquid hindered amine light stabilizer, | Light stabilizer | BASF |
| | Bis(1,2,2,6,6-pentamethyl-4- | | |
| | piperidyl)sebacate + methyl 1,2,2,6,6- | | |
| | pentamethyl-4-piperidyl sebacate | | |
| CRAYVALLAC | Amide-based wax | Thixitrope | Arkama product |
| SLT | | agent | |
| T-12 | 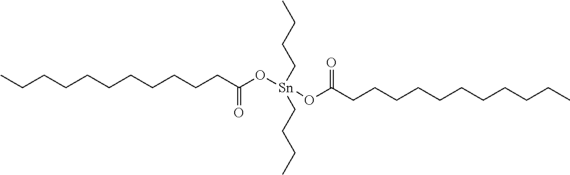 [SMILES: CCCCCCCCCCCC(=O)[O][Sn]([CH2]CCC)([CH2]CCC)[O]C(=O)CCCCCCCCCCC] | Catalyst | SEHOTECH INC |
| | T-12 | | |

### Preparation Example: Preparation of SMP (SPUR-4000-12000)

Voranol™ 4000LM (4000 g) was added into a three neck flask with N₂ protection at room temperature, and heated at 110° C. for 4 hours under a nitrogen flow. The substance in the flask was cooled down to 80° C., then T12 (2.0 g) and IPDI (296.4 g) were added therein, and the flask was further heated at 80° C. for 4 hours. Then SCA-3303 (156.93) was added into the flask and the mixture was heated at 80° C. for 4 hours. After the reaction, the resultant SMP was transferred into a sealed bottle for further characterization, formulation and test.

### Inventive Examples

Different two-component curable compositions were prepared according to the formulations listed in Tables 2 to 7, wherein the relation between relative amounts of each ingredient and the resultant technical effect is studied, and the SMP resin was either prepared in the above stated Preparation Example (SPUR-4000-12000) or commercially purchased (SPUR+ 1015LM).

According to the formulations illustrated in table 2 to 7, Part A and Part B were prepared separately by mixing the ingredients thereof in separate speed mixers under a stirring rate of 2,000 rpm/min. The Part A and Part B were combined and mixed thoroughly in a speed mixer under a stirring speed of 1,000 rpm/min for 20 seconds, under 1,500 rpm/min for 20 seconds, then further mixed in a vacuum mixer having a pressure of 0.2 KPa under 1,000 rpm/min for 2 minutes, and finally mixed in a speed mixer under 2,000 rpm/min for 20 seconds. After the above stated mixing step, the resultant blend was either directly characterized or applied onto the surface of a substrate to produce a film sample.

The samples prepared in the Examples were characterized with the following technologies.

A. The SMP (SPUR-4000-12000) prepared in the above stated preparation example was characterized with Gel Permeation Chromatography (GPC) by using the following conditions and parameters: the GPC was conducted by using an Agilent 1200 model chromatograph equipped with two mixed D columns (7.8×300 mm) and an Agilent Refractive Index detector; the column temperature is 35° C., the temperature of the detector is 35° C., the flow rate is 1.0 mL/min, the mobile phase is tetrahydrofuran, the injection volume is 50 μL; the detection data was collected and analyzed with an Agilent GPC software based on a calibration curve obtained by using a PL Polystyrene Narrow standard (Part No.: 2010-0101) with molecular weights ranging from 316,500 to 316,580 g/mol.

It was measured that the SMP has a Mn of 21,662 and a Mw of 41,081, hence it can be calculated that it has a PDI of 1.90.

B. The tack-free time/skin formulation time was characterized by the following procedures: the two parts of the 2k adhesive sample were mixed and the blend was coated on the surface of a galvanized steel, then the sample was smoothed and skin time testing is carried out according to GB/T 13477.5-2002.

C. The mechanical properties of the samples were measured according to ASTM D1708-06A. According to the procedures introduced in ASTM D1708-06A, the cured films of any examples were die-cut into a dog-bone-shaped specimen. The specimens were fixed on an Instron 5566 instrument and stretched at a constant speed of 50 mm/min. The load at the yield point (if any), the maximum load carried by the specimen during the test, the load at rupture, and the elongation (extension between grips) at the moment of rupture were recorded. The lap shear strengths of the specimens were also measured on the Instron 5566 instrument with an adhesion area of 2.5 cm×2.5 cm. In particular, the specimens were cured at room temperature (22-25° C.), and then the lap shear strengths were tested after different time such as 1, 4, 7 12, 24 or 168 hours. The measured results were also summarized in Table 2 to Table 7.

It can be seen that the Examples and Comparative Examples shown in Table 2 to Table 5 comprise epoxy-silane compatibilizer, and nitrogen-containing unsaturated heterocyclic compound catalyst and nitrogen-containing phenol catalyst were contained as essential ingredients.

TABLE 2
The formulations and characterization of Examples 1-10

| Example No. | Ex. 1 | Ex. 2 | Ex. 3 | Ex. 4 | Ex. 5 | Ex. 6 | Ex. 7 | Ex. 8 | Ex. 9 | Ex. 10 |
|---|---|---|---|---|---|---|---|---|---|---|
| Part A | A-1 | A-1 | A-1 | A-1 | A-1 | A-1 | A-1 | A-1 | A-1 | A-1 |
| SPUR-4000- | 48 | 48 | 48 | 48 | 48 | 48 | 48 | 48 | 48 | 48 |
| 12000 (wt %) | | | | | | | | | | |
| CaCO₃ (wt %) | 22.55 | 22.55 | 22.55 | 22.55 | 22.55 | 22.55 | 22.55 | 22.55 | 22.55 | 22.55 |
| KH 560 (wt %) | 3.4 | 3.4 | 3.4 | 3.4 | 3.4 | 3.4 | 3.4 | 3.4 | 3.4 | 3.4 |
| VTMS (wt %) | 0.8 | 0.8 | 0.8 | 0.8 | 0.8 | 0.8 | 0.8 | 0.8 | 0.8 | 0.8 |
| DINP (wt %) | 14.5 | 14.5 | 14.5 | 14.5 | 14.5 | 14.5 | 14.5 | 14.5 | 14.5 | 14.5 |
| TiO₂ (wt %) | 2 | 2 | 2 | 2 | 2 | 2 | 2 | 2 | 2 | 2 |
| SLT (wt %) | 0.5 | 0.5 | 0.5 | 0.5 | 0.5 | 0.5 | 0.5 | 0.5 | 0.5 | 0.5 |
| D.E.R.383 (wt %) | 8 | 8 | 8 | 8 | 8 | 8 | 8 | 8 | 8 | 8 |
| DMT (wt %) | 0.25 | 0.25 | 0.25 | 0.25 | 0.25 | 0.25 | 0.25 | 0.25 | 0.25 | 0.25 |
| Sum of A (wt) | 100 | 100 | 100 | 100 | 100 | 100 | 100 | 100 | 100 | 100 |
| Part B | B-1 | B-2 | B-3 | B-4 | B-5 | B-6 | B-7 | B-8 | B-9 | B-10 |
| Water (wt %) | 1.5 | 2 | 2.5 | 3 | 3.5 | 4 | 3 | 3 | 3 | 3 |
| TETA (wt %) | 1.5 | 1.5 | 1.5 | 1.5 | 1.5 | 1.5 | 1.5 | 1.5 | 1.5 | 1.5 |
| DBU (wt %) | 1.5 | 1.5 | 1.5 | 1.5 | 1.5 | 1.5 | 2 | 2.5 | 3 | 3.5 |
| DMP-30 (wt %) | 0.15 | 0.15 | 0.15 | 0.15 | 0.15 | 0.15 | 0.15 | 0.15 | 0.15 | 0.15 |
| DINP (wt %) | 46.5 | 46 | 45.5 | 45 | 44.5 | 44 | 44.5 | 44 | 43.5 | 43 |
| CaCO₃ (wt %) | 48.65 | 48.65 | 48.65 | 48.65 | 48.65 | 48.65 | 48.65 | 48.65 | 48.65 | 48.65 |
| Carbon (wt %) | 0.2 | 0.2 | 0.2 | 0.2 | 0.2 | 0.2 | 0.2 | 0.2 | 0.2 | 0.2 |
| Sum of B (wt %) | 100 | 100 | 100 | 100 | 100 | 100 | 100 | 100 | 100 | 100 |
| Weight ratio | 100/100 | 100/100 | 100/100 | 100/100 | 100/100 | 100/100 | 100/100 | 100/100 | 100/100 | 100/100 |
| of A/B | | | | | | | | | | |
| Skin time (mins) | 25 | 19 | 16 | 14 | 14 | 13 | 11 | 9 | 7 | 5 |

As can be seen from the above table 2, SMIP, epoxy, epoxy silane and DMT were contained in Part A while water, DBU and DMP-30 were contained in part B. The skin time can be significantly shortened to about 5 minutes by adjusting the relative amount of the cure-accelerating catalyst.

TABLE 3
The formulations and characterization of
Examples 11-16 and Comparative Example 1

| | Com. | | | | | | |
|---|---|---|---|---|---|---|---|
| Example No. | Ex. 1 | Ex. 11 | Ex. 12 | Ex. 13 | Ex. 14 | Ex. 15 | Ex. 16 |
| Part A | A2 | A3 | A4 | A5 | A6 | A7 | A8 |
| SPUR-4000- | 56 | 53.5 | 51 | 48 | 43.5 | 31 | 11 |
| 12000 (wt %) | | | | | | | |
| CaCO₃ (wt %) | 22.05 | 22.05 | 22.05 | 22.05 | 22.05 | 22.05 | 22.05 |
| KH 560 (wt %) | 3.4 | 3.4 | 3.4 | 3.4 | 3.4 | 3.4 | 3.4 |
| VTMS (wt %) | 0.8 | 0.8 | 0.8 | 0.8 | 0.8 | 0.8 | 0.8 |
| DINP (wt %) | 14.5 | 14.5 | 14.5 | 14.5 | 14.5 | 14.5 | 14.5 |
| TiO₂ (wt %) | 2 | 2 | 2 | 2 | 2 | 2 | 2 |
| SLT (wt %) | 0.5 | 0.5 | 0.5 | 0.5 | 0.5 | 0.5 | 0.5 |
| D.E.R.383 (wt %) | 0 | 2.5 | 5 | 8 | 12.5 | 25 | 45 |
| DMT (wt %) | 0.25 | 0.25 | 0.25 | 0.25 | 0.25 | 0.25 | 0.25 |
| Irganox 1135 (wt %) | 0.25 | 0.25 | 0.25 | 0.25 | 0.25 | 0.25 | 0.25 |
| Tinuvin 765 (wt %) | 0.25 | 0.25 | 0.25 | 0.25 | 0.25 | 0.25 | 0.25 |
| Sum of A (wt %) | 100 | 100 | 100 | 100 | 100 | 100 | 100 |
| Part B | B11 | B12 | B12 | B12 | B12 | B12 | B12 |
| Water (wt %) | 3 | 3 | 3 | 3 | 3 | 3 | 3 |
| TETA (wt %) | 0.25 | 1.5 | 1.5 | 1.5 | 1.5 | 1.5 | 1.5 |
| DBU (wt %) | 3 | 3 | 3 | 3 | 3 | 3 | 3 |
| DMP-30 (wt %) | 0.05 | 0.15 | 0.15 | 0.15 | 0.15 | 0.15 | 0.15 |
| DINP (wt %) | 45.15 | 44.5 | 44.5 | 44.5 | 44.5 | 44.5 | 44.5 |
| CaCO₃ (wt %) | 48.35 | 47.65 | 47.65 | 47.65 | 47.65 | 47.65 | 47.65 |
| Carbon (wt %) | 0.2 | 0.2 | 0.2 | 0.2 | 0.2 | 0.2 | 0.2 |
| Sum B (wt %) | 100 | 100 | 100 | 100 | 100 | 100 | 100 |
| Weight ratio of A/B | 100/100 | 100/100 | 100/100 | 100/100 | 100/100 | 100/100 | 100/100 |
| Property | | | | | | | |
| Skin time (mins) | 8 | 8 | 8 | 7 | 7 | 7 | 8 |
| Elongation at break (%) | 198.4 | 210 | 230.5 | 228.8 | 226.2 | 287 | 390.1 |
| Tensile strength (MPa) | 1.7 | 1.7 | 1.8 | 2.4 | 2 | 1.6 | 1.3 |
| Modulus (MPa) | 1.7 | 1.5 | 1.4 | 2.3 | 2.6 | 2.8 | 0.6 |
| Lap shear strength after | 0.4 | 0.3 | 0.6 | 2.5 | 3.1 | 2.9 | 0.8 |
| 1 week (MPa) | | | | | | | |

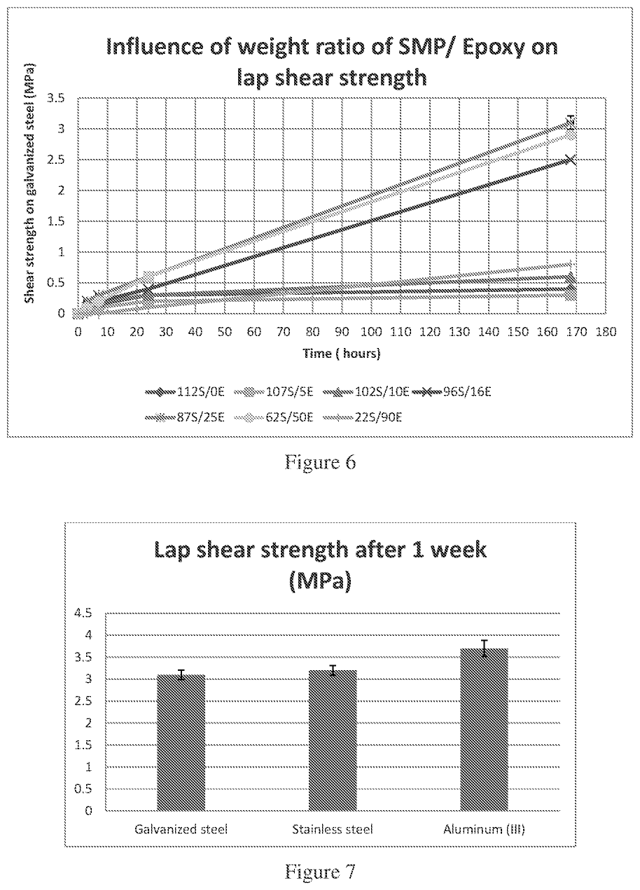

The influence of SMP/epoxy resin weight ratio on the mechanical properties was studied in the examples shown in Table 2 and FIG. 6.

TABLE 4
The lap shear of a sample prepared by Example 17
on different substrates

| Example No. | Ex. 17 |
|---|---|
| Part A | A6 |
| SPUR-4000-12000 (wt %) | 43.5 |
| CaCO3 (wt %) | 22.05 |
| KH 560 (wt %) | 3.4 |
| VTMS (wt %) | 0.8 |
| DINP (wt %) | 14.5 |
| TiO₂ (wt %) | 2 |
| SLT (wt %) | 0.5 |
| D.E.R.383 (wt %) | 12.5 |
| DMT (wt %) | 0.25 |
| Irganox 1135 (wt %) | 0.25 |
| Tinuvin 765 (wt %) | 0.25 |
| Sum A (wt %) | 100 |
| Part B | B12 |
| Water (wt %) | 3 |
| TETA (wt %) | 1.5 |
| DBU (wt %) | 6 |
| DMP-30 (wt %) | 0.15 |
| DINP (wt %) | 42.15 |
| CaCO₃ (wt %) | 47 |
| Carbon (wt %) | 0.2 |
| Sum B (wt %) | 100 |
| weight ratio of A/B | 100/100 |
| Skin time | 7 |

Example 17 was prepared by using the above formulation, then Part A and Part B were blended, and the blend was applied on different substrates. The mechanical properties of these samples were measured after one week. The samples exhibited an elongation at break of 226.2%, a tensile strength of 2.0 MPa and a modulus of 2.6 MPa, and the lap shear strengths of these samples were illustrated in FIG. 7.

TABLE 5
The formulation and characterization of Examples 18 to 22

| Example No. | Ex. 18 | Ex. 19 | Ex. 20 | Ex. 21 | Ex.22 |
|---|---|---|---|---|---|
| Part A | A6 | A9 | A10 | A11 | A12 |
| SPUR-4000-12000 (wt %) | 43.50 | 68.56 | 45.03 | 43.50 | 0 |
| Momentive SPUR + 1015LM | 0 | 0 | 0 | 0 | 43.50 |
| CaCO₃ (wt %) | 22.05 | 0.00 | 22.83 | 22.05 | 21.5 |
| KH 560 (wt %) | 3.40 | 5.36 | 0.00 | 3.40 | 3.4 |
| VTMS (wt %) | 0.80 | 1.26 | 0.83 | 0.80 | 0.8 |
| DINP (wt %) | 14.50 | 0.00 | 15.01 | 14.50 | 15 |
| TiO₂ (wt %) | 2.00 | 3.15 | 2.07 | 2.00 | 2 |
| SLT (wt %) | 0.50 | 0.79 | 0.52 | 0.50 | 0.5 |
| D.E.R.383 (wt %) | 12.50 | 19.70 | 12.94 | 12.50 | 12.5 |
| DMT (wt %) | 0.25 | 0.39 | 0.26 | 0.25 | 0.3 |
| Irganox 1135 (wt %) | 0.25 | 0.39 | 0.26 | 0.25 | 0.25 |
| Tinuvin 765 (wt %) | 0.25 | 0.39 | 0.26 | 0.25 | 0.25 |
| Sum A (wt %) | 100 | 100 | 100 | 100 | 100 |
| Part B | B12 | B13 | B12 | B14 | B-15 |
| Water (wt %) | 3.00 | 38.22 | 3.00 | 3.00 | 3 |
| TETA (wt %) | 1.50 | 19.11 | 1.50 | 1.50 | 1.5 |
| DBU (wt %) | 3.00 | 38.22 | 3.00 | 3.00 | 6 |
| DMP-30 (wt %) | 0.15 | 1.91 | 0.15 | 0.00 | 0.15 |
| DINP (wt %) | 44.50 | 0.00 | 44.50 | 44.57 | 42.15 |
| CaCO₃ (wt %) | 47.65 | 0.00 | 47.65 | 47.72 | 47 |
| Carbon (wt %) | 0.20 | 2.55 | 0.20 | 0.20 | 0.2 |
| Sum B (wt %) | 100 | 100 | 100 | 100 | 100 |
| Weight ratio of A/B | 100/100 | 100/12.4 | 100/103.4 | 100/99.9 | 100/100 |
| Property | | | | | |
| Skin time (mins) | 7 | 7 | 12 | 13 | 7 |
| Elongation at break (%) | 226.20 | 124.90 | 307.20 | 221.00 | — |
| Tensile strength (MPa) | 2.00 | 3.12 | 1.82 | 2.10 | — |
| Modulus (MPa) | 2.60 | 3.26 | 1.05 | 2.40 | — |
| Lap shear strength after 1 week (MPa) | 3.10 | 4.70 | 2.10 | 2.90 | — |

In the experiments shown in table 5, the influence of relative amounts of different ingredients, such as filler, plasticizer, compatibilizer and cure-accelerating, on skin time and mechanical properties were studied.

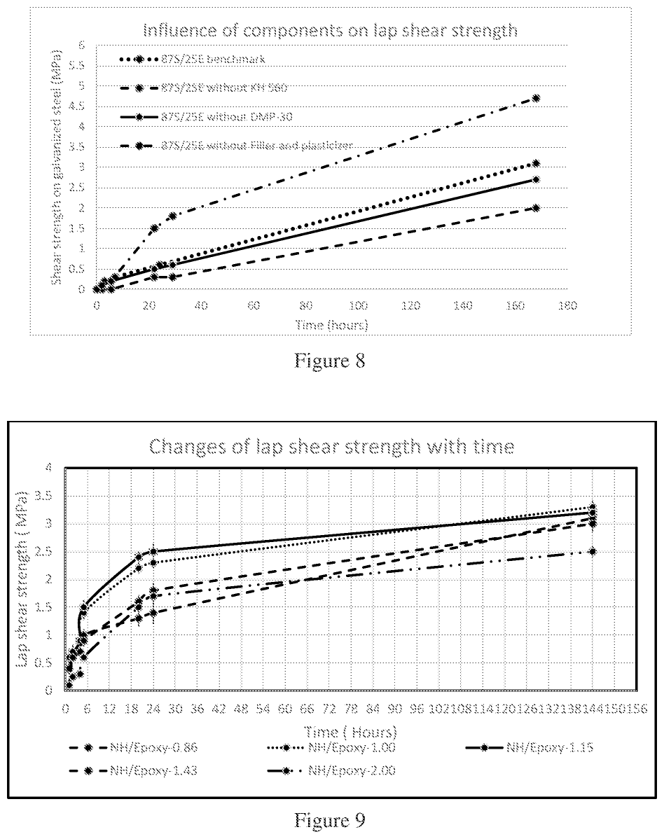

Three additional comparative experiments were conducted to study the change of lap shear strength over time. In particular, these three comparative experiments were conducted by repeating the formulation and procedures of Example 22, except that KH560, DMP-30 or “filler and plasticizer” were omitted. The lap shear strength for each sample was measured after one week, and the experimental results of Example 22 and these three comparative experiments are shown in FIG. 8. Example 23 was conducted by replacing the SMP obtained by the above said preparation example (SPUR-4000-12000) with a commercial purchased SMP Momentive SPUR+1015LM, and the sample of Example 23 also exhibit a skin time of around 7 minutes.

On the other hands, the Examples and Comparative Examples shown in Table 6 to Table 7 comprise amino-silane compatibilizer and optional nitrogen-containing unsaturated heterocyclic compound catalyst. The nitrogen-containing phenol catalyst and water were not contained in the Examples and Comparative Examples shown in Table 6 to Table 7.

In the inventive examples and comparative examples shown in Table 6, the weight ratio of PartA/part B is fixed at 1/1, the SPUR/Epoxy weight ratio is fixed at about 3/1, the dosage of SPUR in Part A is fixed at 48%, and the dosage of epoxy resin in Part B is kept at 16% in part B. The dosage of DBU in part A is increased from 0% to 0.5%, 1%, 2% and 3%, while the dosage of DMT in part B is increased from 0% to 1%. As displayed by the experimental data, when the dosage of both DBU and DMT is 0%, a dry surface can be obtained with a skin time of around 27 minutes, which could not meet the requirement of the customer, which sometimes requires a skin time of less than 20 minutes. When the dosage of DMT is kept at 1 wt % and the amount of DBU varies at 0, 0.5% and 1%, a dry surface can be achieved with a skin time of 17 minutes, 15 minutes and 14 minutes, respectively, and both the surface morphology and skin time can meet customer's needs. According to the comparative examples 3 and 4, further increase of the dosage of DBU to 2% or 3% with the dosage of DMT being kept at 1 wt % can further decrease the skin time decreased to 13 minutes or 9 minutes. Unfortunately, these two comparative examples exhibit undesirable surface properties including oil surface or sticky surface, which could not meet the customer's need.

TABLE 6
The formulation and characterization of
Examples 24 to 26 and Comparative Document 2 to 4

| | | | | | | |
|---|---|---|---|---|---|---|
| Samples | Com. Ex. 2 | Ex. 24 | Ex. 25 | Ex. 26 | Com. Ex. 3 | Com. Ex. 4 |

Part A

| | | | | | | |
|---|---|---|---|---|---|---|
| SPUR + 1050 | 48 | 48 | 48 | 48 | 48 | 48 |
| Z-6020 | 8 | 8 | 8 | 8 | 8 | 8 |
| VTMS | 0.6 | 0.6 | 0.6 | 0.6 | 0.6 | 0.6 |
| DBU | 0 | 0 | 0.5 | 1 | 2 | 3 |
| CaCO₃ | 32 | 32 | 32 | 32 | 32 | 32 |
| DINP | 7.5 | 7.5 | 7 | 6.5 | 5.5 | 4.5 |
| SLT | 1.4 | 1.4 | 1.4 | 1.4 | 1.4 | 1.4 |
| Irganox 1135 | 0.25 | 0.25 | 0.25 | 0.25 | 0.25 | 0.25 |
| Tinuvin 765 | 0.25 | 0.25 | 0.25 | 0.25 | 0.25 | 0.25 |
| TiO₂ | 2 | 2 | 2 | 2 | 2 | 2 |
| Sum | 100 | 100 | 100 | 100 | 100 | 100 |

Part B

| | | | | | | |
|---|---|---|---|---|---|---|
| D.E.R.383 | 16 | 16 | 16 | 16 | 16 | 16 |
| DMT | 0 | 1 | 1 | 1 | 1 | 1 |
| DINP | 25 | 24 | 24 | 24 | 24 | 24 |
| CaCO₃ | 58.98 | 58.98 | 58.98 | 58.98 | 58.98 | 58.98 |
| Carbon | 0.02 | 0.02 | 0.02 | 0.02 | 0.02 | 0.02 |
| sum | 100 | 100 | 100 | 100 | 100 | 100 |
| Skin time | 27 | 17 | 15 | 14 | 13 | 9 |
| (mins) | | | | | | |
| Surface | dry | dry | dry | dry | oil | oil |
| morphology | surface | surface | surface | surface | surface | surface |

In the experimental results illustrated in Table 6, “oil surface” refers to a deteriorated and undesirable surface morphology exhibiting sticky, greasy and oil-like feeling, while “dry surface” refers to a surface being free of the above stated undesirable properties. As can be seen from the above Table 6, short skin time and good surface property can only be achieved by using optimized formulation.

In the inventive examples and comparative examples shown in Table 7, the dosage of DBU and DMT are fixed on 1%, the weight ratio of part A/part B is fixed at 1/1, the SMP/Epoxy weight ratio is fixed at about 3/1, the dosage of SPUR in Part A is fixed at 48%, and the dosage of epoxy resin in Part B is kept at 16% in part B. In these examples shown in Table 7, the dosage of Z 6020 in part A varies at 6%, 7%, 8%, 10% and 14%, corresponding NH/epoxy molar ratio of 0.86, 1.00, 1.15, 1.43 and 2.00, respectively. It can be seen from table 7 and FIG. 9 that when the NH/epoxy molar ratio is too low or too high, the resultant curable composition will exhibit undesirable properties such as decreased molecular weight and slow adhesion build up.

TABLE 7
The formulation and characterization of Examples 27
to 28 and Comparative Document 5 to 7

| | | | | | |
|---|---|---|---|---|---|
| | Com. | | | Com. | Com. |
| Samples | Ex. 5 | Ex. 27 | Ex.28 | Ex. 6 | Ex. 7 |

Part A

| | | | | | |
|---|---|---|---|---|---|
| SPUR + 1050 | 48.0 | 48.0 | 48.0 | 48.0 | 48.0 |
| Z-6020 | 6.0 | 7.0 | 8.0 | 10.0 | 14.0 |
| VTMS | 0.6 | 0.6 | 0.6 | 0.6 | 0.6 |
| DBU | 1.0 | 1.0 | 1.0 | 1.0 | 1.0 |
| CaCO₃ | 31.7 | 31.7 | 31.7 | 31.7 | 28.7 |
| DINP | 8.8 | 7.8 | 6.8 | 4.8 | 3.8 |
| SLT | 1.4 | 1.4 | 1.4 | 1.4 | 1.4 |
| Irganox 1135 | 0.3 | 0.3 | 0.3 | 0.3 | 0.3 |
| Tinuvin 765 | 0.3 | 0.3 | 0.3 | 0.3 | 0.3 |
| TiO₂ | 2.0 | 2.0 | 2.0 | 2.0 | 2.0 |
| Sum | 100.0 | 100.0 | 100.0 | 100.0 | 100.0 |

Part B

| | | | | | |
|---|---|---|---|---|---|
| D.E.R.383 | 16.0 | 16.0 | 16.0 | 16.0 | 16.0 |
| DMT | 1.0 | 1.0 | 1.0 | 1.0 | 1.0 |
| DINP | 24.0 | 24.0 | 24.0 | 24.0 | 24.0 |
| CaCO₃ | 59.0 | 59.0 | 59.0 | 59.0 | 59.0 |
| Carbon | 0.0 | 0.0 | 0.0 | 0.0 | 0.0 |
| sum | 100.0 | 100.0 | 100.0 | 100.0 | 100.0 |
| Molar ratio of | 0.86 | 1.00 | 1.15 | 1.43 | 2.00 |
| NH/epoxy | | | | | |

Lap shear strength after different times
on galvanized steel (MPa)

| | | | | | |
|---|---|---|---|---|---|
| 1 hour | 0.4 | 0.6 | 0.6 | 0.1 | 0.1 |
| 2 hours | 0.6 | 0.7 | 0.7 | 0.6 | 0.3 |
| 4 hours | 0.7 | 0.9 | 0.9 | 0.7 | 0.3 |
| 5 hours | 1.0 | 1.4 | 1.5 | 0.9 | 0.6 |
| 20 hours | 1.3 | 2.2 | 2.4 | 1.6 | 1.5 |
| 24 hours | 1.4 | 2.3 | 2.5 | 1.8 | 1.7 |
| 144 hours | 3.1 | 3.3 | 3.2 | 3.0 | 2.5 |

The relation between the formulation of the curable composition and the lap shear strength on galvanized steel was studied in the above Table 7 and FIG. 9.

Without being limited to any specific theory, the curable composition of the present disclosure exhibits superior performance properties including a short skin time of as low as 20 to 5 minutes, a good lap shear strength of 2.5 to 5 MPa, an elongation at break of 100% to 300%, a tensile strength of 2.0 to 3.5 MPa and a modulus of 2.0-3.5 MPa.

1. A curable composition, comprising
at least one silane modified polymer;
at least one epoxy resin terminated with epoxy group;
at least one compatibilizer which has at least one silane group and at least one epoxy terminal group, or has at least one silane group and at least one nitrogen-containing group in the same molecule;
optionally, at least one hardening agent;
at least one nitrogen-containing unsaturated heterocyclic compound catalyst at a concentration in a range of 0.5 to 20 wt % when the compatibilizer is an epoxy silane compatibilizer and in a range of zero to 20 wt % when the compatibilizer is an amino-silane compatibilizer with wt % relative to weight of curable composition; and
optionally, at least one nitrogen-containing phenol catalyst;
wherein the curable composition is a two-component curable composition comprising a component A and a component B,
wherein the component A comprises the silane modified polymer, the epoxy resin and the compatibilizer which has at least one silane group and at least one epoxy terminal group, and the component B comprises the hardening agent, the nitrogen-containing unsaturated heterocyclic compound catalyst and the nitrogen-containing phenol catalyst; or
wherein the component A comprises the silane modified polymer, the compatibilizer which has at least one silane group and at least one nitrogen-containing group in the same molecule and optionally, the nitrogen-containing unsaturated heterocyclic compound catalyst, and the component B comprises the epoxy resin; and
wherein the curable composition comprises water in component B at a concentration in a range of 0.5 wt % to 4 wt % based on weight of the curable composition.

2. (canceled)

3. (canceled)

4. The curable composition according to claim 1, wherein the nitrogen-containing unsaturated heterocyclic compound catalyst is selected from the group consisting of 1,8-diazabicyclo[5.4.0]undec-7-ene, 1,5-diazabicyclo[4.3.0]non-5-ene, 2,3-diazabicyclo[2.2.0] hex-1-ene and 1,3-diazabicyclo[3.1.0]hex-3-ene.

5. The curable composition according to claim 1, wherein the nitrogen-containing phenol catalyst is selected from the group consisting of 2,4,6-tris(R₀)phenol, 2,4-bis(R₀)phenol, 2,3-bis(R₀)phenol, 3,4-bis(R₀)phenol, 2,6-bis(R₀)phenol, 2,5-bis(R₀)phenol and 3,5-bis(R₀)phenol, wherein each R₀ is independently selected from the group consisting of amino(C₁-C₆)alkyl, (C₁-C₆)alkylamino(C₁-C₆)alkyl and di(C₁-C₆)alkylamino(C₁-C₆)alkyl.

6. The curable composition according to claim 1, wherein the silane modified polymer is represented by formula I:
R¹ₘ(R²O)₍₃₋ₘ₎Si—R⁷-(polymeric main chain)-R⁸—SiR³ₙ(R⁴O)₍₃₋ₙ₎ Formula I
wherein the polymeric main chain is derived from a polyol, or derived from at least one polyisocyanate and at least one polyol, and is optionally functionalized with at least one —R⁹—SiR⁵ₛ(R⁶O)₍₃₋ₛ₎, each of R¹, R², R³, R⁴, R⁵ and R⁶ independently represents a hydrogen atom or a C₁-C₆ alkyl group, each of m, n and s represents an integrate of 0, 1 or 2, each of R⁷, R⁸ and R⁹ independently represents a direct bond, —O—, a divalent (C₁ to C₆ alkylene) group, —O—(C₁ to C₆ alkylene) group, (C₁ to C₆ alkylene)-O— group, —O—(C₁ to C₆ alkylene)-O— group, —N(R_{N})—(C₁ to C₆ alkylene) group or —C(═O)—N(R_{N})—(C₁ to C₆ alkylene) group, wherein R_{N} represents a hydrogen atom or a C₁-C₆ alkyl group.

7. The curable composition according to claim 1, wherein hardening agent is selected from the group consisting of aliphatic amine, alicyclic amine, aromatic amine, polyaminoamide, imidazole, dicyandiamides, epoxy-modified amines, Mannich-modified amines, Michael addition-modified amines and ketimines.

8. The curable composition according to claim 1, wherein the compatibilizer is a compound having at least one silane group and at least one epoxy terminal group, and is represented by formula II, or a condensation oligomer/polymer thereof: 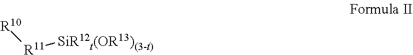
wherein R¹⁰ is selected a group consisting of 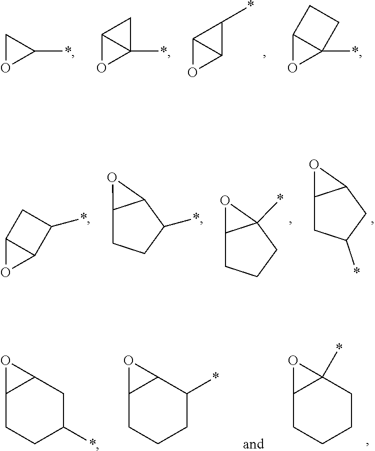
wherein * represents the linkage site,
R¹¹ is selected from a group consisting of C₂-C₆ alkylene, —(CH₂—O)—C₂-C₆ alkylene, —C₂-C₆ alkylene-Si(C₁-C₆ alkyl)₂-C₂-C₆ alkylene, —(CH₂—O)—C₂-C₆ alkylene-Si(C₁-C₆ alkyl)₂-C₂-C₆ alkylene, —C₂-C₆ alkylene-Si(C₁-C₆ alkoxy)₂-C₂-C₆ alkylene, —(CH₂—O)—C₂-C₆ alkylene-Si(C₁-C₆ alkoxy)₂-C₂-C₆ alkylene, —(CH₂—O)—C₂-C₆ alkylene-Si(C₁-C₆ alkyl)₂-C₂-C₆ alkylene-(O—CH₂)—CH(OH)—CH₂—NH—C₂-C₆ alkylene, —(CH₂—O)—C₂-C₆ alkylene-Si(C₁-C₆ alkoxy)₂-C₂-C₆ alkylene-(O—CH₂)—CH(OH)—CH₂—NH—C₂-C₆ alkylene, —(CH₂—O)—C₂-C₆ alkylene-Si(C₁-C₆ alkyl)₂-[O—Si(C₁-C₆ alkyl)₂]ₓ—C₂-C₆ alkylene-(O—CH₂)—CH(OH)—CH₂—NH—C₂-C₆ alkylene, —(CH₂—O)—C₂-C₆ alkylene-Si(C₁-C₆ alkoxy)₂-[O—Si(C₁-C₆ alkoxy)₂]ₓ—C₂-C₆ alkylene-(O—CH₂)—CH(OH)—CH₂—NH—C₂-C₆ alkylene,
wherein each of R¹² and R¹³ independently represents a hydrogen atom or a C₁-C₆ alkyl group optionally substituted with C₁-C₆ alkyl group, C₁-C₆ alkoxy group, halogen atom, C₂-C₆ alkeny group, C₂-C₆ alkynyl group, —Si(C₁-C₄ alkyl)₃, —Si(C₁-C₄ alkoxy)₃, —Si—{O—[Si(C₁-C₄alkoxy)₃]₃, —(C₁-C₆)alkylene-Si(C₁-C₄ alkyl)₃, —(C₁-C₆)alkylene —Si(C₁-C₄ alkoxy)₃ or —(C₁-C₆)alkylene-Si—{O—[Si(C₁-C₄ alkoxy)₃]₃,
t represents an integer of 0, 1 or 2, and x represents an integer of 1 to 100.

9. The curable composition according to claim 8, wherein the compatibilizer is a condensation oligomer or condensation polymer represented by formula III, 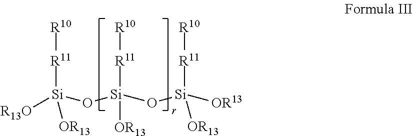
wherein R¹⁰ is selected a group consisting of 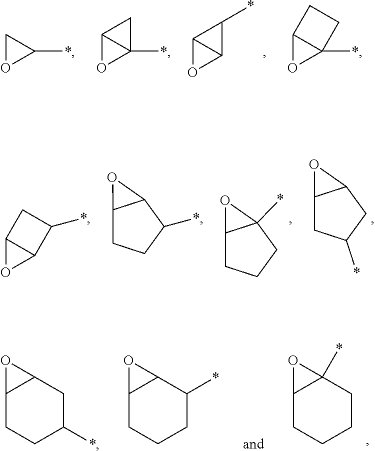
wherein * represents the linkage site,
R¹¹ is selected from a group consisting of C₂-C₆ alkylene, —(CH₂—O)—C₂-C₆ alkylene, —C₂-C₆ alkylene-Si(C₁-C₆ alkyl)₂-C₂-C₆ alkylene, —(CH₂—O)—C₂-C₆ alkylene-Si(C₁-C₆ alkyl)₂-C₂-C₆ alkylene, —C₂-C₆ alkylene-Si(C₁-C₆ alkoxy)₂-C₂-C₆ alkylene, —(CH₂—O)—C₂-C₆ alkylene-Si(C₁-C₆ alkoxy)₂-C₂-C₆ alkylene, —(CH₂—O)—C₂-C₆ alkylene-Si(C₁-C₆ alkyl)₂-C₂-C₆ alkylene-(O—CH₂)—CH(OH)—CH₂—NH—C₂-C₆ alkylene, —(CH₂—O)—C₂-C₆ alkylene-Si(C₁-C₆ alkoxy)₂-C₂-C₆ alkylene-(O—CH₂)—CH(OH)—CH₂—NH—C₂-C₆ alkylene, —(CH₂—O)—C₂-C₆ alkylene-Si(C₁-C₆ alkyl)₂-[O—Si(C₁-C₆ alkyl)₂]ₓ—C₂-C₆ alkylene-(O—CH₂)—CH(OH)—CH₂—NH—C₂-C₆ alkylene, —(CH₂—O)—C₂-C₆ alkylene-Si(C₁-C₆ alkoxy)₂-[O—Si(C₁-C₆ alkoxy)₂]X—C₂-C₆ alkylene-(O—CH₂)—CH(OH)—CH₂—NH—C₂-C₆ alkylene,
R¹³ represents a hydrogen atom or a C₁-C₆ alkyl group optionally substituted with C₁-C₆ alkyl group, C₁-C₆ alkoxy group, halogen atom, C₂-C₆ alkeny group, C₂-C₆ alkynyl group, —Si(C₁-C₄ alkyl)₃, —Si(C₁-C₄ alkoxy)₃, —Si—{O—[Si(C₁-C₄alkoxy)₃]₃, —(C₁-C₆)alkylene-Si(C₁-C₄ alkyl)₃, —(C₁-C₆)alkylene —Si(C₁-C₄ alkoxy)₃ or -(C₁—C₆)alkylene-Si—{O—[Si(C₁-C₄ alkoxy)₃]₃,
r represents an integer of 1 to 50, and x represents an integer of 1 to 100.

10. The curable composition according to claim 8, wherein the compatibilizer is selected from a group consisting of 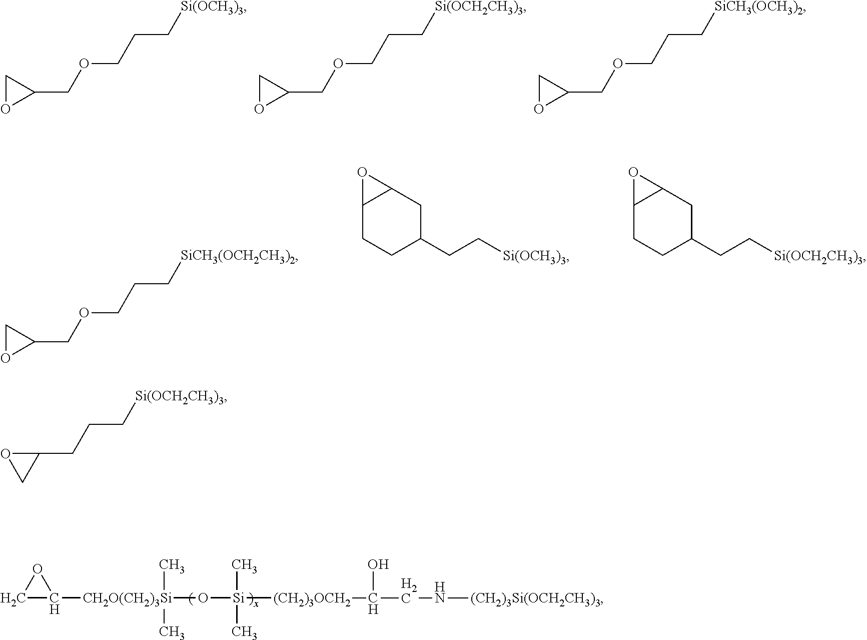
wherein x represents an integer of 1 to 100, 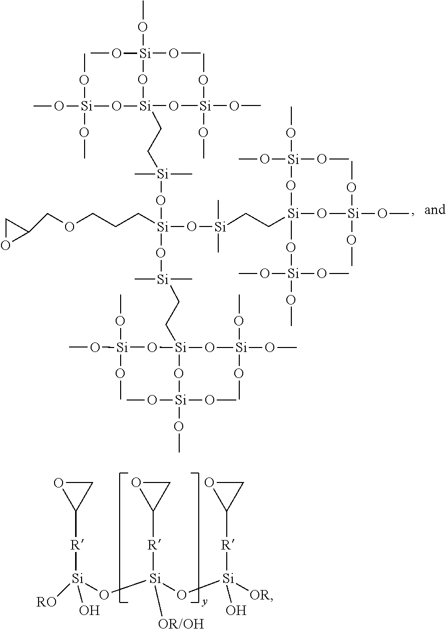
wherein R′ is selected from a group consisting of C₂-C₆ alkylene, —(CH₂—O)—C₂-C₆ alkylene, —C₂-C₆ alkylene-Si(C₁-C₆ alkyl)₂-C₂-C₆ alkylene, —(CH₂—O)—C₂-C₆ alkylene-Si(C₁-C₆ alkyl)₂-C₂-C₆ alkylene, —C₂-C₆ alkylene-Si(C₁-C₆ alkoxy)₂-C₂-C₆ alkylene, —(CH₂—O)—C₂-C₆ alkylene-Si(C₁-C₆ alkoxy)₂-C₂-C₆ alkylene, —(CH₂—O)—C₂-C₆ alkylene-Si(C₁-C₆ alkyl)₂-C₂-C₆ alkylene-(O—CH₂)—CH(OH)—CH₂—NH—C₂-C₆ alkylene, —(CH₂—O)—C₂-C₆ alkylene-Si(C₁-C₆ alkoxy)₂-C₂-C₆ alkylene-(O—CH₂)—CH(OH)—CH₂—NH—C₂-C₆ alkylene, —(CH₂—O)—C₂-C₆ alkylene-Si(C₁-C₆ alkyl)₂-[O—Si(C₁-C₆ alkyl)₂]ₓ—C₂-C₆ alkylene-(O—CH₂)—CH(OH)—CH₂—NH—C₂-C₆ alkylene, —(CH₂—O)—C₂-C₆ alkylene-Si(C₁-C₆ alkoxy)₂-[O—Si(C₁-C₆ alkoxy)₂]ₓ—C₂-C₆ alkylene-(O—CH₂)—CH(OH)—CH₂—NH—C₂-C₆ alkylene, R represents a hydrogen atom or a C₁-C₆ alkyl group optionally substituted with C₁-C₆ alkyl group, C₁-C₆ alkoxy group, halogen atom, C₂-C₆ alkeny group, C₂-C₆ alkynyl group, —Si(C₁-C₄ alkyl)₄, —Si(C₁-C₄ alkoxy)₃, —Si—{O—[Si(C₁-C₄alkoxy)₄]₃, —(C₁-C₆)alkylene-Si(C₁-C₄ alkyl)₃, —(C₁-C₆)alkylene —Si(C₁-C₄ alkoxy)₃ or —(C₁-C₆)alkylene-Si—{O—[Si(C₁-C₄alkoxy)₃]₃, and y represents an integer of 1 to 50.

11. The curable composition according to claim 1, wherein the compatibilizer is a compound having at least one silane group and at least one nitrogen-containing group in the same molecule, and is represented by formula IV: 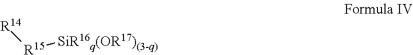
wherein R¹⁴ is selected a group consisting of NH₂—, pyridinyl, pyrryl, NH₂(C₁-C₆ alkylene)-, NH₂(C₁-C₆ alkylene)-NH—, NH₂(C₁-C₁₀ alkylene-O)—NH—, (NH₂)₂CH—, (NH₂)₃C—, (NH₂—C₁-C₆ alkylene)₂ CH—, (NH₂—C₁-C₆ alkylene)₃C—, (NH₂)₂CH(C₁-C₆ alkylene)-, (NH₂)₃C(C₁-C₆ alkylene)-, (NH₂—C₁-C₆ alkylene)₂CH(C₁-C₆ alkylene)-, (NH₂—C₁-C₆ alkylene)₃C(C₁-C₆ alkylene)-, phenylNH—, (C₁-C₆alkyl)NH—, (C₁-C₆alkyl)₂N—, (C₁-C₆cycloalkyl)NH—, (C₁-C₆cycloalkyl)₂N—, (C₁-C₆alkenyl)NH—, (C₁-C₆alkenyl)₂N—, (hydroxyC₁-C₆alkyl)NH—, (hydroxyC₁-C₆alkyl)₂N—, R¹⁵ is selected from a group consisting of a direct bond, phenylene, —(C₁-C₆ alkylene)-, phenylene-(C₁-C₆ alkylene)-, —NH—(C₁-C₆ alkylene)-, —NH—NH—(C₁-C₆ alkylene)-, —NH—(C₁-C₆ alkylene)-NH—, —NH—(C₁-C₆ alkylene)-NH—(C₁-C₆ alkylene)- and —NH—(C₁-C₆ alkylene)-NH—(C₁-C₆ alkylene)-NH—,
wherein each of R¹⁶ and R¹⁷ independently represents a hydrogen atom or a C₁-C₆ alkyl group optionally substituted with C₁-C₆ alkyl group, C₁-C₆ alkoxy group, —(C₁-C₆)alkylene-O—C₁-C₆ alkyl group, —(C₁-C₆)alkylene-O—(C₁-C₆)alkylene-O—C₁-C₆ alkyl group, halogen atom, C₂-C₆ alkeny group, C₂-C₆ alkynyl group, —Si(C₁-C₄ alkyl)₃, —Si(C₁-C₄ alkoxy)₃, —Si—{O—[Si(C₁-C₄alkoxy)₃]₃, —(C₁-C₆)alkylene-Si(C₁-C₄ alkyl)₃, —(C₁-C₆)alkylene-Si(C₁-C₄ alkoxy)₃ or —(C₁-C₆)alkylene-Si-{0-[Si(C₁-C₄ alkoxy)₃]₃,
q represents an integer of 0, 1 or 2,
with the proviso that there are at least one nitrogen atom in the compound represented by formula IV.

12. The curable composition according to claim 11, wherein the compatibilizer is selected from a group consisting of

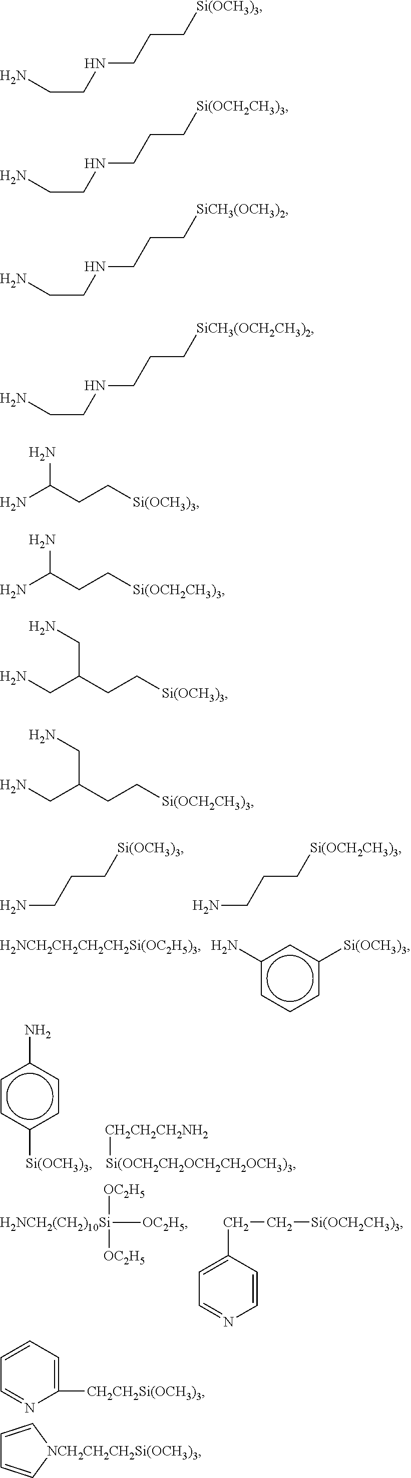

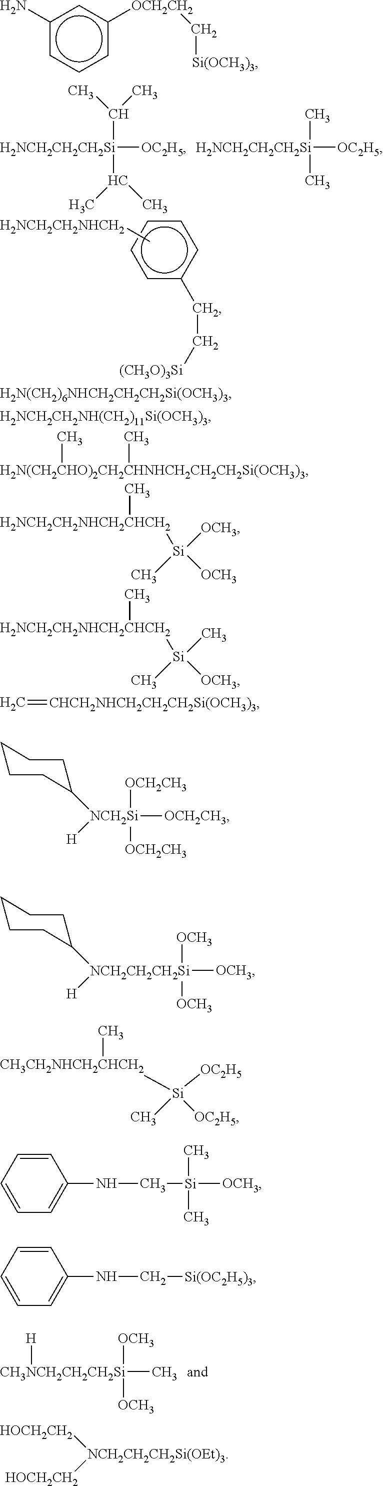

13. The curable composition according to claim 1, wherein the silane modified polymer comprises 15 to 70 wt % of the curable composition, the epoxy resin comprises 2.5 to 65 wt % of the curable composition, the hardening agent comprises 0 to 8 wt % of the curable composition, the compatibilizer comprises 0.5 to 20 wt % of the curable composition, the nitrogen-containing unsaturated heterocyclic compound catalyst comprises 0 to 20 wt % of the curable composition, and the nitrogen-containing phenol catalyst comprises 0 to 5 wt % of the curable composition.

14. A method for applying the curable composition according to claim 1 onto a surface of a substrate, comprising the steps of
(1) combining the silane modified polymer, the epoxy resin, the compatibilizer, and the optional hardening agent, nitrogen-containing unsaturated heterocyclic compound catalyst and nitrogen-containing phenol catalyst to form a precursor blend;
(2) applying the precursor blend onto a surface of a substrate; and
(3) curing the precursor blend, or allowing the precursor blend to cure.
